(19) United States
(12) Patent Application Publication
(10) Pub. No.: US 2026/0371428 A1
(43) Pub. Date: Nov. 19, 2026

(54) Extremely High Frequency Link Setup

(71) Applicant: Ofinno, LLC, Reston, VA (US)

(72) Inventors: Leonardo Alisasis Lanante, Reston, VA (US); Jeongki Kim, Fairfax, VA (US); Esmael Hejazi Dinan, McLean, VA (US); Serhat Erkucuk, Reston, VA (US); Tuncer Baykas, Reston, VA (US); Jiayi Zhang, Rockville, MD (US)

(73) Assignee: Ofinno, LLC, Reston, VA (US)

(21) Appl. No.: 19/752,165

(22) Filed: Jul. 23, 2026

Related U.S. Application Data
(63) Continuation of application No. PCT/US2025/012661, filed on Jan. 23, 2025.
(60) Provisional application No. 63/625,310, filed on Jan. 26, 2024.

(51) Int. Cl. H04W 76/15; H04W 84/12

(52) U.S. Cl. CPC H04W 76/15; H04W 84/12

(57) ABSTRACT

A first station (STA) receives, from an access point (AP) and via a first link, a beacon frame. Based on a receive signal strength indicator (RSSI) of the beacon frame being less than a threshold: the first STA detects a second frame transmitted via a second link by the AP to a second STA, and based on detecting the second frame the first STA transmits to the AP a third frame comprising a request to establish the second link between the first STA and the AP.

### CROSS-REFERENCE TO RELATED APPLICATIONS

This application is a continuation of International Application No. PCT/US2025/012661, filed Jan. 23, 2025, which claims the benefit of U.S. Provisional Application No. 63/625,310, filed Jan. 26, 2024, all of which are hereby incorporated by reference in their entireties.

### BRIEF DESCRIPTION OF THE DRAWINGS

Examples of several of the various embodiments of the present disclosure are described herein with reference to the drawings.

FIG. 1 illustrates example wireless communication networks in which embodiments of the present disclosure may be implemented.

FIG. 2 is a block diagram illustrating example implementations of a station (STA) and an access point (AP).

FIG. 3 illustrates an example of a Medium Access Control (MAC) frame format.

FIG. 4 illustrates an example of a Quality of Service (QoS) null frame indicating buffer status information.

FIG. 5 illustrates an example format of a physical layer (PHY) protocol data unit (PPDU).

FIG. 6 illustrates an example that includes buffer status reporting by STAs, scheduling by an AP of uplink multi-user (MU) transmissions, and transmission of scheduled uplink transmissions by the STAs.

FIG. 7 illustrates an example reference model for a multi-link device (MLD).

FIG. 8 illustrates an example of an AP MLD and an associated non-AP MLD.

FIG. 9 illustrates an example of a multi-link setup between an AP MLD and a non-AP MLD.

FIG. 10 illustrates an example of a traffic identifier (TID)-to-link mapping in a multi-link communication environment.

FIG. 11 illustrates an example multi-link configuration between an AP MLD and a non-AP MLD that includes an extremely high frequency link.

FIG. 12 illustrates an example of an extremely high frequency (EHF) link setup procedure based on signal strength associated with a non-EHF link.

FIG. 13 illustrates an example link setup process according to an embodiment.

FIG. 14 illustrates an example of the link setup process illustrated in FIG. 13.

FIG. 15 illustrates another example of the link setup process illustrated in FIG. 13.

FIG. 16 illustrates an example of another link setup process according to an embodiment.

FIG. 17 illustrates an example of another link setup process according to an embodiment.

FIG. 18 illustrates an example process according to an embodiment.

FIG. 19 illustrates an example process according to an embodiment.

FIG. 20 illustrates an example process according to an embodiment.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. After reading the description, it will be apparent to one skilled in the relevant art how to implement alternative embodiments. The present embodiments may not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Embodiments may be configured to operate as needed. The disclosed mechanism may be performed when certain criteria are met, for example, in a station, an access point, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

In this disclosure, “a” and “an” and similar phrases are to be interpreted as “at least one” and “one or more.” Similarly, any term that ends with the suffix “(s)” is to be interpreted as “at least one” and “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described. The term “based on”, as used herein, may be interpreted as “based at least in part on” rather than, for example, “based solely on”. The term “and/or” as used herein represents any possible combination of enumerated elements. For example, “A, B, and/or C” may represent A; B; C; A and B; A and C; B and C; or A, B, and C.

If A and B are sets and every element of A is an element of B, A is called a subset of B. In this specification, only non-empty sets and subsets are considered. For example, possible subsets of B={STA1, STA2} are: {STA1}, {STA2}, and {STA1, STA2}. The phrase “based on” (or equally “based at least on”) is indicative that the phrase following the term “based on” is an example of one of a multitude of suitable possibilities that may, or may not, be employed to one or more of the various embodiments. The phrase “in response to” (or equally “in response at least to”) is indicative that the phrase following the phrase “in response to” is an example of one of a multitude of suitable possibilities that may, or may not, be employed to one or more of the various embodiments. The phrase “depending on” (or equally “depending at least to”) is indicative that the phrase following the phrase “depending on” is an example of one of a multitude of suitable possibilities that may, or may not, be employed to one or more of the various embodiments. The phrase “employing/using” (or equally “employing/using at least”) is indicative that the phrase following the phrase “employing/using” is an example of one of a multitude of suitable possibilities that may, or may not, be employed to one or more of the various embodiments.

The term configured may relate to the capacity of a device whether the device is in an operational or non-operational state. Configured may refer to specific settings in a device that effect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, parameters (or equally called, fields, or Information elements: IEs) may comprise one or more information objects, and an information object may comprise one or more other objects. For example, if parameter (IE) N comprises parameter (IE) M, and parameter (IE) M comprises parameter (IE) K, and parameter (IE) K comprises parameter (information element) J. Then, for example, N comprises K, and N comprises J. In an example embodiment, when one or more messages/frames comprise a plurality of parameters, it implies that a parameter in the plurality of parameters is in at least one of the one or more messages/frames but does not have to be in each of the one or more messages/frames.

Many features presented are described as being optional through the use of “may” or the use of parentheses. For the sake of brevity and legibility, the present disclosure does not explicitly recite each and every permutation that may be obtained by choosing from the set of optional features. The present disclosure is to be interpreted as explicitly disclosing all such permutations. For example, a system described as having three optional features may be embodied in seven ways, namely with just one of the three possible features, with any two of the three possible features or with three of the three possible features.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g. hardware with a biological element) or a combination thereof, which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

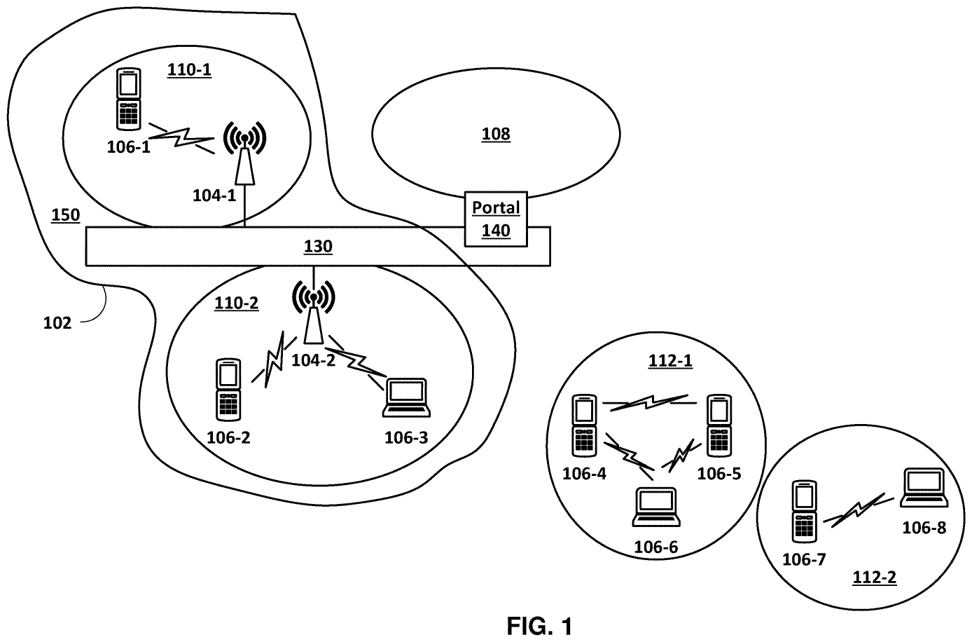

FIG. 1 illustrates example wireless communication networks in which embodiments of the present disclosure may be implemented.

As shown in FIG. 1, the example wireless communication networks may include an Institute of Electrical and Electronic Engineers (IEEE) 802.11 (WLAN) infra-structure network 102. WLAN infra-structure network 102 may include one or more basic service sets (BSSs) 110 and 120 and a distribution system (DS) 130.

BSS 110-1 and 110-2 each includes a set of an access point (AP or AP STA) and at least one station (STA or non-AP STA). For example, BSS 110-1 includes an AP 104-1 and a STA 106-1, and BSS 110-2 includes an AP 104-2 and STAs 106-2 and 106-3. The AP and the at least one STA in a BSS perform an association procedure to communicate with each other.

DS 130 may be configured to connect BSS 110-1 and BSS 110-2. As such, DS 130 may enable an extended service set (ESS) 150. Within ESS 150, APs 104-1 and 104-2 are connected via DS 130and may have the same service set identification (SSID).

WLAN infra-structure network 102 may be coupled to one or more external networks. For example, as shown in FIG. 1, WLAN infra-structure network 102 may be connected to another network 108 (e.g., 802.X) via a portal 140. Portal 140 may function as a bridge connecting DS 130 of WLAN infra-structure network 102 with the other network 108.

The example wireless communication networks illustrated in FIG. 1 may further include one or more ad-hoc networks or independent BSSs (IBSSs). An ad-hoc network or IBSS is a network that includes a plurality of STAs that are within communication range of each other. The plurality of STAs are configured so that they may communicate with each other using direct peer-to-peer communication (i.e., not via an AP).

For example, in FIG. 1, STAs 106-4, 106-5, and 106-6 may be configured to form a first IBSS 112-1. Similarly, STAs 106-7 and 106-8 may be configured to form a second IBSS 112-2. Since an IBSS does not include an AP, it does not include a centralized management entity. Rather, STAs within an IBSS are managed in a distributed manner. STAs forming an IBSS may be fixed or mobile.

A STA as a predetermined functional medium may include a medium access control (MAC) layer that complies with an IEEE 802.11 standard. A physical layer interface for a radio medium may be used among the APs and the non-AP stations (STAs). The STA may also be referred to using various other terms, including mobile terminal, wireless device, wireless transmit/receive unit (WTRU), user equipment (UE), mobile station (MS), mobile subscriber unit, or user. For example, the term “user” may be used to denote a STA participating in uplink Multi-user Multiple Input, Multiple Output (MU MIMO) and/or uplink Orthogonal Frequency Division Multiple Access (OFDMA) transmission.

A physical layer (PHY) protocol data unit (PPDU) may be a composite structure that includes a PHY preamble and a payload in the form of a PLCP service data unit (PSDU). For example, the PSDU may include a PHY Convergence Protocol (PLCP) preamble and header and/or one or more MAC protocol data units (MPDUs). The information provided in the PHY preamble may be used by a receiving device to decode the subsequent data in the PSDU. In instances in which PPDUs are transmitted over a bonded channel (channel formed through channel bonding), the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is based on the particular IEEE 802.11 protocol to be used to transmit the payload.

A frequency band may include one or more sub-bands or frequency channels. For example, PPDUs conforming to the IEEE 802.11n, 802.11ac, 802.11ax and/or 802.11be standard amendments may be transmitted over the 2.4 GHz, 5 GHz, and/or 6 GHz bands, each of which may be divided into multiple 20 MHz channels. The PPDUs may be transmitted over a physical channel having a minimum bandwidth of 20 MHz. Larger channels may be formed through channel bonding. For example, PPDUs may be transmitted over physical channels having bandwidths of 40 MHz, 80 MHz, 160 MHz, or 520 MHz by bonding together multiple 20 MHz channels.

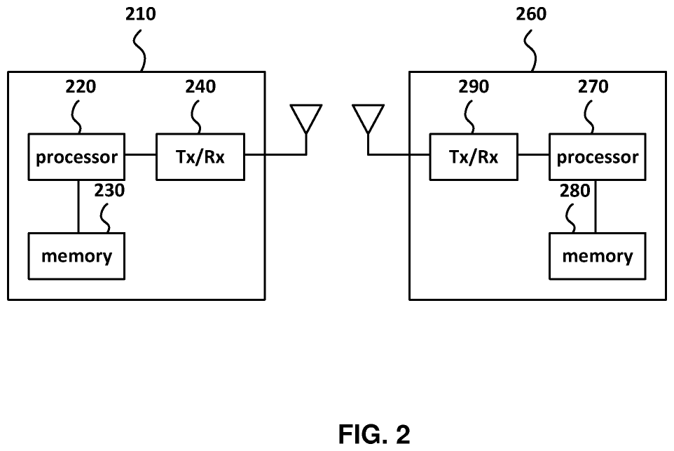

FIG. 2 is a block diagram illustrating example implementations of a STA 210 and an AP 260. As shown in FIG. 2, STA 210 may include at least one processor 220, a memory 230, and at least one transceiver 240. AP 260 may include at least one processor 270, a memory 280, and at least one transceiver 290. Processor 220/270 may be operatively connected to memory 230/280 and/or to transceiver 240/290.

Processor 220/270 may implement functions of the PHY layer, the MAC layer, and/or the logical link control (LLC) layer of the corresponding device (STA 210 or AP 260). Processor 220/270 may include one or more processors and/or one or more controllers. The one or more processors and/or one or more controllers may comprise, for example, a general-purpose processor, a digital signal processor (DSP), a microcontroller, an application specific integrated circuit (ASIC), a field programmable gate array (FPGA), a logic circuit, or a chipset, for example.

Memory 230/280 may include a read-only memory (ROM), a random-access memory (RAM), a flash memory, a memory card, a storage medium, and/or other storage unit. Memory 230/280 may comprise one or more non-transitory computer readable mediums. Memory 230/280 may store computer program instructions or code that may be executed by processor 220/270 to carry out one or more of the operations/embodiments discussed in the present application. Memory 230/280 may be implemented (or positioned) within processor 220/270 or external to processor 220/270. Memory 230/280 may be operatively connected to processor 220/270 via various means known in the art.

Transceiver 240/290 may be configured to transmit/receive radio signals. In an embodiment, transceiver 240/290 may implement a PHY layer of the corresponding device (STA 210 or AP 260). In an embodiment, STA 210 and/or AP 260 may be a multi-link device (MLD), that is a device capable of operating over multiple links as defined by the IEEE 802.11 standard. As such, STA 210 and/or AP 260 may each implement multiple PHY layers. The multiple PHY layers may be implemented using one or more of transceivers 240/290.

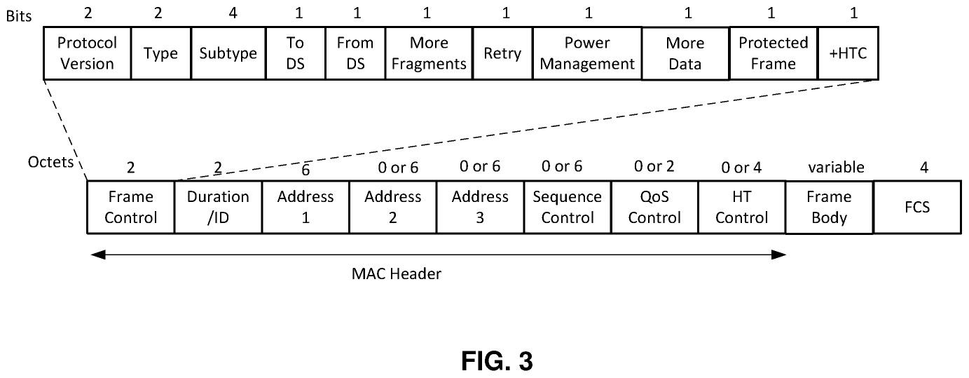

FIG. 3 illustrates an example format of a MAC frame. In operation, a STA may construct a subset of MAC frames for transmission and may decode a subset of received MAC frames upon validation. The particular subsets of frames that a STA may construct and/or decode may be determined by the functions supported by the STA. A STA may validate a received MAC frame using the frame check sequence (FCS) contained in the frame and may interpret certain fields from the MAC headers of all frames.

As shown in FIG. 3, a MAC frame includes a MAC header, a variable length frame body, and a frame check sequence (FCS).

The MAC header includes a frame control field, an optional duration/ID field, address fields, an optional sequence control field, an optional QoS control field, and an optional HT control field.

The frame control field includes the following subfields: protocol version, type, subtype, “To DS”, “From DS”, “More Fragments”, retry, power management, “More Data”, protected frame, and +HTC.

The protocol version subfield is invariant in size and placement across all revisions of the IEEE 802.11 standard. The value of the protocol version subfield is 0 for MAC frames.

The type and subtype subfields together identify the function of the MAC frame. There are three frame types: control, data, and management. Each of the frame types has several defined subtypes. Bits within the subtype subfield are used to indicate a specific modification of the basic data frame (subtype 0). For example, in data frames, the most significant bit (MSB) of the subtype subfield, bit 7 (B7) of the frame control field, is defined as the QoS subfield. When the QoS subfield is set to 1, it indicates a QoS data frame, which is a data frame that contains a QoS control field in its MAC header. The second MSB of the subtype field, bit 6 (B6) of the frame control field, when set to 1 in data subtypes, indicates a data frame that contain no frame body field.

The “To DS” subfield indicates whether a data frame is destined to the distribution system (DS). The “From DS” subfield indicates whether a data frame originates from the DS.

The “More Fragments” subfield is set to 1 in all data or management frames that have another fragment to follow the MAC service data unit (MSDU) or MAC management protocol data unit (MMPDU) carried by the MAC frame. The “More Fragments” subfield is set to 0 in all other frames in which the “More Fragments” subfield is present.

The retry subfield is set to 1 in any data or management frame that is a retransmission of an earlier frame. It is set to 0 in all other frames in which the retry subfield is present. A receiving STA uses this indication to aid it in the process of eliminating duplicate frames. These rules do not apply for frames sent by a STA under a block agreement.

The power management subfield is used to indicate the power management mode of a STA.

The “More Data” subfield indicates to a STA in power save (PS) mode that bufferable units (BUs) are buffered for that STA at the AP. The “More Data” subfield is valid in individually addressed data or management frames transmitted by an AP to a STA in PS mode. The “More Data” subfield is set to 1 to indicate that at least one additional buffered BU is present for the STA.

The protected frame subfield is set to 1 if the frame body field contains information that has been processed by a cryptographic encapsulation algorithm.

The +HTC subfield indicates that the MAC frame contains an HT control field.

The duration/ID field of the MAC header indicates various contents depending on the frame type and subtype and the QoS capabilities of the sending STA. For example, in control frames of the power save poll (PS-Poll) subtype, the duration/ID field carries an association identifier (AID) of the STA that transmitted the frame in the 14 least significant bits (LSB), with the 2 most significant bits (MSB) set to 1. In other frames sent by STAs, the duration/ID field contains a duration value (in microseconds) which is used by a recipient to update a network allocation vector (NAV). The NAV is a counter that indicates to a STA an amount of time during which the STA must defer from accessing the shared medium.

Up to four address fields may be present in the MAC frame format. The address fields are used to indicate the basic service set identifier (BSSID), source address (SA), destination address (DA), transmitting address (TA), and receiving address (RA). Certain frames may not contain some of the address fields. Certain address field usage may be specified by the relative position of the address field (1-4) within the MAC header, independent of the type of address present in that field. Specifically, the address 1 field always identifies the intended receiver(s) of the frame, and the address 2 field, where present, always identifies the transmitter of the frame.

The sequence control field includes two subfields, a sequence number subfield and a fragment number subfield. The sequence number subfield in data frames indicates the sequence number of the MSDU (if not in an Aggregated MSDU (A-MSDU)) or A-MSDU. The sequence number subfield in management frames indicates the sequence number of the frame. The fragment number subfield indicates the number of each fragment of an MSDU or MMPDU. The fragment number is set to 0 in the first or only fragment of an MSDU or MMPDU and is incremented by one for each successive fragment of that MSDU or MMPDU. The fragment number is set to 0 in a MAC protocol data unit (MPDU) containing an A-MSDU, or in an MPDU containing an MSDU or MMPDU that is not fragmented. The fragment number remains constant in all retransmissions of the fragment.

The QoS control field identifies the traffic category (TC) or traffic stream (TS) to which the MAC frame belongs. The QoS control field may also indicate various other QoS related, A-MSDU related, and mesh-related information about the frame. This information can vary by frame type, frame subtype, and type of transmitting STA. The QoS control field is present in all data frames in which the QoS subfield of the subtype subfield is equal to 1.

The HT control field is present in QoS data, QoS null, and management frames as determined by the +HTC subfield of the frame control field.

The frame body field is a variable length field that contains information specific to individual frame types and subtypes. The frame body may include one or more MSDUs or MMPDUs. The minimum length of the frame body is 0 octets.

The FCS field contains a 32-bit Cyclic Redundancy Check (CRC) code. The FCS field value is calculated over all of the fields of the MAC header and the frame body field.

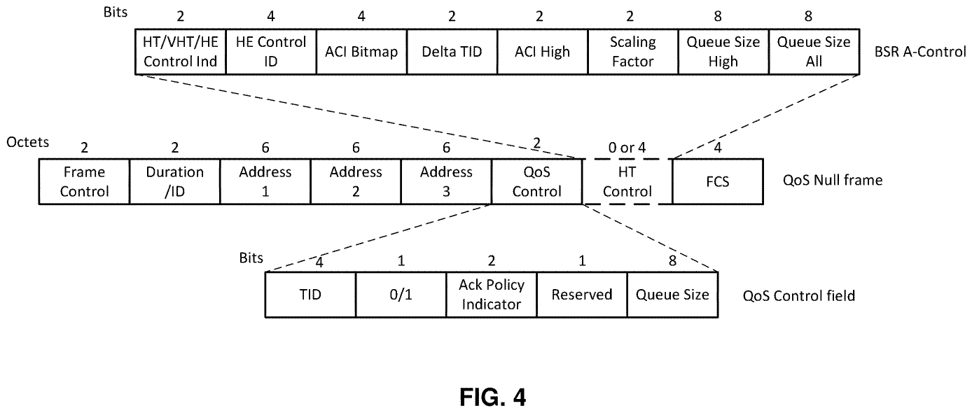

FIG. 4 illustrates an example of a QoS null frame indicating buffer status information. A QoS null frame refers to a QoS data frame with an empty frame body. A QoS null frame includes a QoS control field and an optional HT control field which may contain a buffer status report (BSR) control subfield. A QoS null frame indicating buffer status information may be transmitted by a STA to an AP.

The QoS control field may include a traffic identifier (TID) subfield, an ack policy indicator subfield, and a queue size subfield (or a transmission opportunity (TXOP) duration requested subfield).

The TID subfield identifies the TC or TS of traffic for which a TXOP is being requested, through the setting of the TXOP duration requested or queue size subfield. The encoding of the TID subfield depends on the access policy (e.g., Allowed value 0 to 7 for enhanced distributed channel access (EDCA) access policy to identify user priority for either TC or TS).

The ack policy indicator subfield, together with other information, identifies the acknowledgment policy followed upon delivery of the MPDU (e.g., normal ack, implicit block ack request, no ack, block ack, etc.)

The queue size subfield is an 8-bit field that indicates the amount of buffered traffic for a given TC or TS at the STA for transmission to the AP identified by the receiver address of the frame containing the subfield. The queue size subfield is present in QoS null frames sent by a STA when bit 4 of the QoS control field is set to 1. The AP may use information contained in the queue size subfield to determine t TXOP duration assigned to the STA or to determine the uplink (UL) resources assigned to the STA.

In a frame sent by or to a non-High Efficiency (non-HE) STA, the following rules may apply to the queue size value:
The queue size value is the approximate total size, rounded up to the nearest multiple of 256 octets and expressed in units of 256 octets, of all MSDUs and A-MSDUs buffered at the STA (excluding the MSDU or A-MSDU contained in the present QoS Data frame) in the delivery queue used for MSDUs and A-MSDUs with TID values equal to the value indicated in the TID subfield of the QoS Control field.
A queue size value of 0 is used solely to indicate the absence of any buffered traffic in the queue used for the specified TID.
A queue size value of 254 is used for all sizes greater than 64 768 octets.
A queue size value of 255 is used to indicate an unspecified or unknown size.

In a frame sent by an HE STA to an HE AP, the following rules may apply to the queue size value.

The queue size value, QS, is the approximate total size in octets, of all MSDUs and A-MSDUs buffered at the STA (including the MSDUs or A-MSDUs contained in the same PSDU as the frame containing the queue size subfield) in the delivery queue used for MSDUs and A-MSDUs with TID values equal to the value indicated in the TID subfield of the QoS control field.

The queue size subfield includes a scaling factor subfield in bits B14-B15 of the QoS control field and an unscaled value, UV, in bits B8-B13 of the QoS control field. The scaling factor subfield provides the scaling factor, SF.

A STA obtains the queue size, QS, from a received QoS control field, which contains a scaling factor, SF, and an unscaled value, UV, as follows:
QS=
16×UV, if SF is equal to 0;
1024+256×UV, if SF is equal to 1;
17 408+2048×UV, if SF is equal to 2;
148 480 +32 768 ×UV, if SF is equal to 3 and UV is less than 62;
>2 147 328, if SF equal to is 3 and UV is equal to 62;
Unspecified or Unknown, if SF is equal to 3 and UV is equal to 63.

The TXOP duration requested subfield, which may be included instead of the queue size subfield, indicates the duration, in units of 32 microseconds (us), that the sending STA determines it needs for its next TXOP for the specified TID. The TXOP duration requested subfield is set to 0 to indicate that no TXOP is requested for the specified TID in the current service period (SP). The TXOP duration requested subfield is set to a nonzero value to indicate a requested TXOP duration in the range of 32 us to 8160 us in increments of 32 us.

The HT control field may include a BSR control subfield which may contain buffer status information used for UL MU operation. The BSR control subfield may be formed from an access category index (ACI) bitmap subfield, a delta TID subfield, an ACI high subfield, a scaling factor subfield, a queue size high subfield, and a queue size all subfield of the HT control field.

The ACI bitmap subfield indicates the access categories (ACs) for which buffer status is reported (e.g., B0: best effort (AC_BE), B1: background (AC_BK), B2: video (AC_VI), B3: voice (AC_VO), etc.). Each bit of the ACI bitmap subfield is set to 1 to indicate that the buffer status of the corresponding AC is included in the queue size all subfield, and set to 0 otherwise, except that if the ACI bitmap subfield is 0 and the delta TID subfield is 3, then the buffer status of all 8 TIDs is included.

The delta TID subfield, together with the values of the ACI bitmap subfield, indicate the number of TIDs for which the STA is reporting the buffer status.

The ACI high subfield indicates the ACI of the AC for which the BSR is indicated in the queue size high subfield. The ACI to AC mapping is defined as ACI value 0 mapping to AC_BE, ACI value 1 mapping to AC_BK, ACI value 2 mapping to AC_VI, and ACI value 3 mapping to AC_VO.

The scaling factor subfield indicates the unit SF, in octets, of the queue size high and queue size all subfields.

The queue size high subfield indicates the amount of buffered traffic, in units of SF octets, for the AC identified by the ACI high subfield, that is intended for the STA identified by the receiver address of the frame containing the BSR control subfield.

The queue size all subfield indicates the amount of buffered traffic, in units of SF octets, for all ACs identified by the ACI Bitmap subfield, that is intended for the STA identified by the receiver address of the frame containing the BSR control subfield.

The queue size values in the queue size high and queue size all subfields are the total sizes, rounded up to the nearest multiple of SF octets, of all MSDUs and A-MSDUs buffered at the STA (including the MSDUs or A-MSDUs contained in the same PSDU as the frame containing the BSR control subfield) in delivery queues used for MSDUs and A-MSDUs associated with AC(s) that are specified in the ACI high and ACI bitmap subfields, respectively.

A queue size value of 254 in the queue size high and queue size all subfields indicates that the amount of buffered traffic is greater than 254×SF octets. A queue size value of 255 in the queue size high and queue size all subfields indicates that the amount of buffered traffic is an unspecified or unknown size. The queue size value of QoS data frames containing fragments may remain constant even if the amount of queued traffic changes as successive fragments are transmitted.

MAC service provides peer entities with the ability to exchange MSDUs. To support this service, a local MAC uses the underlying PHY-level service to transport the MSDUs to a peer MAC entity. Such asynchronous MSDU transport is performed on a connectionless basis.

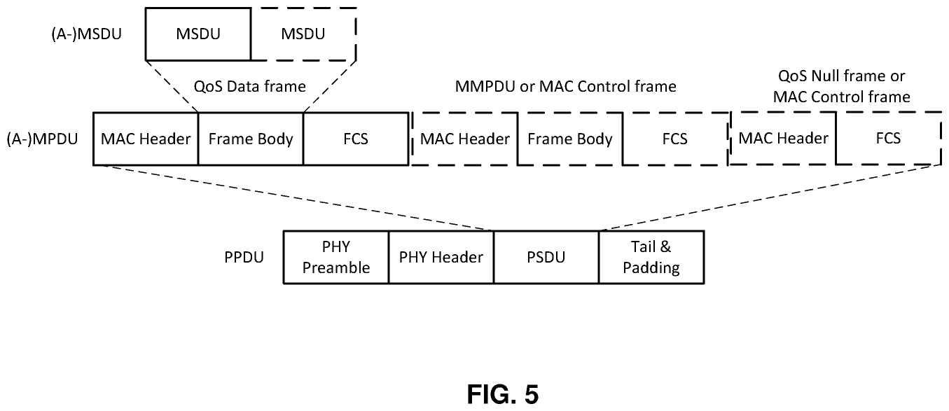

FIG. 5 illustrates an example format of a PPDU. As shown, the PPDU may include a PHY preamble, a PHY header, a PSDU, and tail and padding bits.

The PSDU may include one or more MPDUs, such as a QoS data frame, an MMPDU, a MAC control frame, or a QoS null frame. In the case of an MPDU carrying a QoS data frame, the frame body of the MPDU may include a MSDU or an A-MSDU.

By default, MSDU transport is on a best-effort basis. That is, there is no guarantee that a transmitted MSDU will be delivered successfully. However, the QoS facility uses a traffic identifier (TID) to specify differentiated services on a per-MSDU basis.

A STA may differentiate MSDU delivery according to designated traffic category (TC) or traffic stream (TS) of individual MSDUs. The MAC sublayer entities determine a user priority (UP) for an MSDU based on a TID value provided with the MSDU. The QoS facility supports eight UP values. The UP values range from 0 to 7 and form an ordered sequence of priorities, with 1 being the lowest value, 7 the highest value, and 0 falling between 2 and 3.

An MSDU with a particular UP is said to belong to a traffic category with that UP. The UP may be provided with each MSDU at the medium access control service access point (MAC SAP) directly in a UP parameter. An A-MPDU may include MPDUs with different TID values.

A STA may deliver buffer status reports (BSRs) to assist an AP in allocating UL MU resources. The STA may either implicitly deliver BSRs in the QoS control field or BSR control subfield of any frame transmitted to the AP (unsolicited BSR) or explicitly deliver BSRs in a frame sent to the AP in response to a BSRP Trigger frame (solicited BSR).

The buffer status reported in the QoS control field includes a queue size value for a given TID. The buffer status reported in the BSR control field includes an ACI bitmap, delta TID, a high priority AC, and two queue sizes.

A STA may report buffer status to the AP, in the QoS control field, of transmitted QoS null frames and QoS data frames and, in the BSR control subfield (if present), of transmitted QoS null frames, QoS data frames, and management frames as defined below.

The STA may report the queue size for a given TID in the queue size subfield of the QoS control field of transmitted QoS data frames or QoS null frames; the STA may set the queue size subfield to 255 to indicate an unknown/unspecified queue size for that TID. The STA may aggregate multiple QoS data frames or QoS null frames in an A-MPDU to report the queue size for different TIDs.

The STA may report buffer status in the BSR control subfield of transmitted frames if the AP has indicated its support for receiving the BSR control subfield.

A High-Efficiency (HE) STA may report the queue size for a preferred AC, indicated by the ACI high subfield, in the queue size high subfield of the BSR control subfield. The STA may set the queue size high subfield to 255 to indicate an unknown/unspecified queue size for that AC.

A HE STA may report the queue size for ACs indicated by the ACI bitmap subfield in the queue size all subfield of the BSR control subfield. The STA may set the queue size all subfield to 255 to indicate an unknown/unspecified BSR for those ACs.

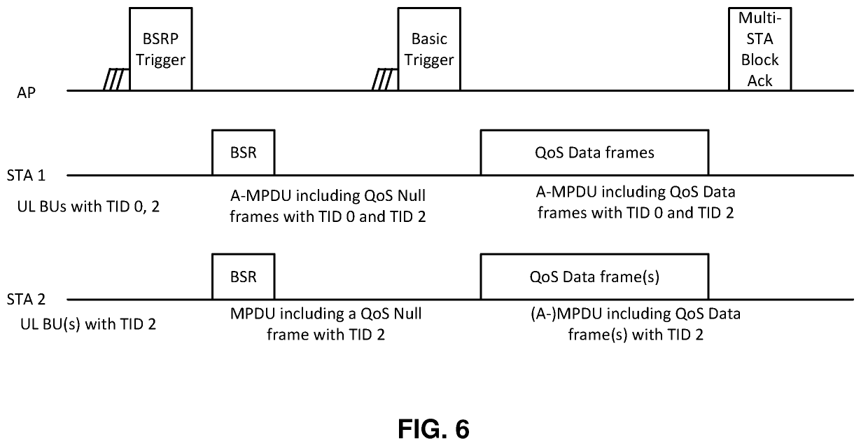

FIG. 6 illustrates an example that includes buffer status reporting by STAs, scheduling by an AP of uplink multi-user (MU) transmissions, and transmission of scheduled uplink transmissions by the STAs.

As shown, the AP may solicit one or more associated STAs (STA 1 and STA 2) for buffer status by sending a buffer status report poll (BSRP) trigger frame. Upon receiving the BSRP trigger frame, STA 1 and/or STA 2 may each generate a trigger-based (TB) PPDU if the BSRP trigger frame contains, in a User Info field, the 12 LSBs of the STA's AID.

STA 1 and/or STA 2 may each include in the TB PPDU one or more QoS null frames. The one or more QoS null frames may contain one or more QoS control fields or one or more BSR control subfields.

As described earlier, a QoS control field may include a queue size subfield for a TID for which the STA has a queue size to report to the AP. For example, as shown in FIG. 6, STA 1 may respond to the BSRP trigger frame from the AP by transmitting an A-MPDU including multiple QoS null frames. The QoS null frames each indicates, in its respective QoS control field, a queue size for a respective TID, e.g. TID 0 and TID 2. Similarly, STA 2 may respond to the BSRP trigger frame by transmitting an MPDU including a QoS null frame, which indicates a queue size for TID 2 in its QoS control field.

A BSR control subfield may include a queue size all subfield indicating the queue size for the ACs, indicated by the ACI bitmap subfield, for which the STA has a queue size to report to the AP if the AP has indicated its support for receiving the BSR control subfield. The STA sets a delta TID, a scaling factor, an ACI high, and the queue size high subfields of the BSR Control subfield.

On receiving the BSRs from STA 1 and STA 2, the AP may transmit a basic trigger frame to allocate UL MU resources to STA 1 and STA 2. In response, STA 1 may transmit a TB PPDU containing QoS data frames with TID 0 and TID 2 and STA 2 may transmit a TB PPDU containing one or more QoS data frame(s) with TID. The AP may acknowledge the transmitted TB PPDUs from STA 1 and STA 2 by sending a multi-STA block ack frame.

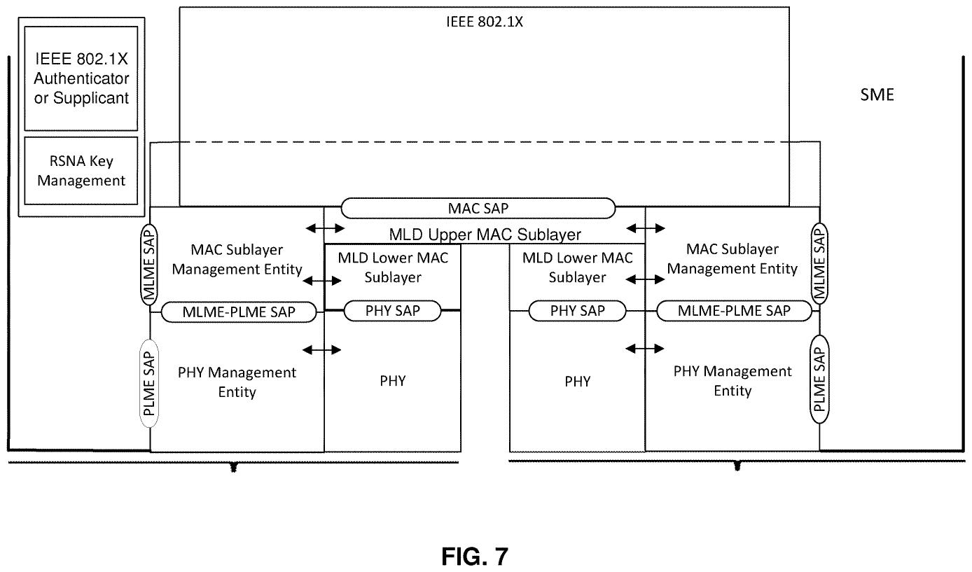

FIG. 7 illustrates an example reference model for a multi-link device (MLD).

An MLD is an entity capable of managing communication over multiple links. The MLD may be a logical entity and may have more than one affiliated station (STA). An MLD may be an access point MLD (AP MLD) where a STA affiliated with the MLD is an AP STA (or an AP). An MLD may be a non-access point MLD (non-AP MLD) where a STA affiliated with the MLD is a non-AP STA (or an STA).

Communication across different frequency bands/channels may occur simultaneously, or not, depending on the capabilities of both of the communicating AP MLD and non-AP MLD.

As shown in FIG. 7, a MLD may have a single MAC service access point (MAC-SAP) to the LLC layer, which includes a MAC data service. The MLD may support multiple MAC sublayers, coordinated by a sublayer management entity (SME). Each AP STA (or non-AP STA) affiliated with an AP MLD (or non-AP MLD) has a different MAC address within the MLD.

The SME is responsible for coordinating the MAC sublayer management entities (MLMEs) of the affiliated STAs of the MLD to maintain a single robust security network association (RSNA) key management entity as well as a single IEEE 802.1X Authenticator or Supplicant for multi-link operation (MLO).

Multi-link operation (MLO) procedures allow a pair of MLDs to discover, synchronize, (de)authenticate, (re)associate, disassociate, and manage resources with each other on any common bands or channels that are supported by both MLDs. The Authenticator and the MAC-SAP of an AP MLD may be identified by the same AP MLD MAC address. The Supplicant and the MAC-SAP of a non-AP MLD may be identified by the same non-AP MLD MAC address.

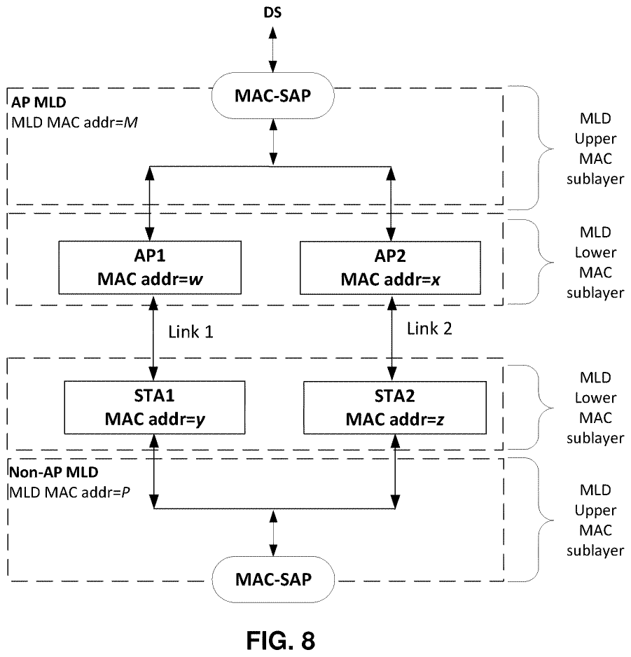

FIG. 8 illustrates an example of an AP MLD and an associated non-AP MLD.

As shown, the AP MLD has two affiliated APs (AP1 and AP2), and the non-AP MLD has two affiliated STAs (STA 1 and STA 2). The AP MLD and the non-AP MLD may be communicatively coupled by two links (Link 1 and Link 2.) Link 1 is established between AP1 and STA1, and link 2 is established between AP2 and STA2.

Generally, the MAC addresses of an MLD and of its affiliated STAs are different from one another. For example, as shown in FIG. 8, the AP MLD may have MAC address M, AP 1 may have MAC address w, and AP2 may have with MAC address x. Similarly, the non-AP MLD may have MAC address P, STA 1 may have MAC address y, and STA2 may have MAC address z.

As shown in FIG. 8, with each MLD, the MAC sublayer may be further divided into an MLD upper MAC sublayer and an MLD lower MAC sublayer. The MLD upper MAC sublayer (MLD) performs functionalities that are common across all links. The MLD lower MAC sublayer performs functionalities that are local to each link. Some of the functionalities require joint processing of both the MLD upper and the MLD lower MAC sublayers.

The MLD upper MAC sublayer functions may include:
Authentication, association, and reassociation (between an AP MLD and a non-AP MLD);
Security association (e.g., pairwise master key security association (PMKSA), pairwise transient key security association (PTKSA)) and distribution of group temporal key (GTK)/integrity GTK (IGTK)/beacon IGTK (BIGTK);
Sequence number (SN)/packet number (PN) assignment for frames to be encrypted by pairwise transient key (PTK) for unicast frames;
Encryption/decryption using PTK for unicast frames;
Selection of the MLD lower MAC sublayer for transmission (TID-to-link mapping);
Reordering of packets to ensure in-order delivery per each Block Ack session;
Block Ack scoreboarding for individually addressed frames (in collaboration with the MLD lower MAC sublayer); optionally, the MLD upper MAC sublayer delivers the Block Ack record on one link to the MLD lower MAC sublayer of other links; and
MLD level management information exchange/indication via the MLD lower MAC sublayer

The MLD lower MAC sublayer functions may include:
Maintenance of link specific GTK/IGTK/BIGTK (between an AP affiliated with the AP MLD and a STA affiliated with the non-AP MLD);
Link-specific encryption/decryption/integrity protection and PN assignment using GTK/IGTK/BIGTK (between an AP affiliated with the AP MLD and a STA affiliated with the non-AP MLD);
Link specific management information exchange/indication (e.g., beacon);
Link specific control information exchange/indication (e.g., RTS/CTS, acknowledgements, etc.);
Power save state and mode;
MAC address filtering for frame reception; and
Block Ack scoreboarding for individually addressed frames (in collaboration with the MLD upper MAC sublayer); optionally, the MLD lower MAC sublayer receives the Block Ack record on the other links from the MLD upper MAC sublayer.

Multi-link (re)setup between a non-AP MLD and an AP MLD may include an exchange of (re)association request/response frames. A (re)association request/response frame exchange for a multi-link setup may include both frames carrying a basic multi-link element.

In the (re)association request frame, the non-AP MLD indicates the links that are requested for (re)setup and the capabilities and operational parameters of the requested links. The non-AP MLD may request to (re)set up links with a subset of APs affiliated with the AP MLD. The links that are requested for (re)setup and the capabilities and operation parameters of requested links are independent of existing setup links with an associated AP MLD and the capabilities and operation parameters of setup links.

In the (re)association response frame, the AP MLD may indicate the requested links that are accepted and the requested links that are rejected for (re)setup and the capabilities and operational parameters of the requested links. The AP MLD may accept a subset of the links that are requested for (re)setup. The (re)association response frame is sent to the non-AP STA, affiliated with the non-AP MLD, that sent the (re)association request frame.

An MLD that requests or accepts multi-link (re)setup for any two links ensures that each link is located on a different nonoverlapping channel. After successful multi-link (re)setup between a non-AP MLD and an AP MLD, the non-AP MLD and the AP MLD set up links for multi-link operation, and the non-AP MLD is (re)associated with the AP MLD. For each setup link, the corresponding non-AP STA affiliated with the non-AP MLD is in the same associated state as the non-AP MLD and is associated with a corresponding AP affiliated with the AP MLD. For each setup link, functionalities between a non-AP STA and its associated AP are enabled unless the functionalities have been extended to the MLD level or specified otherwise.

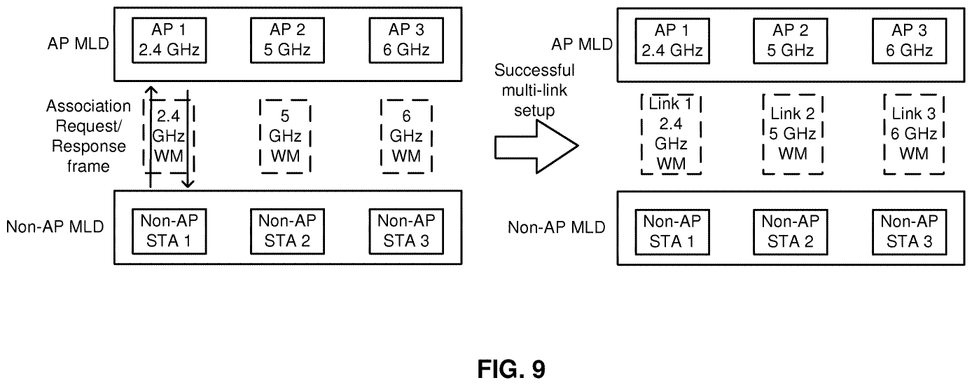

FIG. 9 illustrates an example of a multi-link setup between an AP MLD and a non-AP MLD. As shown, the AP MLD has three affiliated APs: AP 1 operating in the 2.4 GHz band, AP 2 operating in the 5 GHz band, and AP 3 operating in the 6 GHz band. The non-AP MLD has three affiliated STAs: non-AP STA 1 operating in the 2.4 GHz band, non-AP STA 2 operating in the 5 GHz band, and non-AP STA 3 operating in the 6 GHz band.

The non-AP MLD may initiate multi-link setup by non-AP STA 1 sending an association request frame to AP 1 affiliated with the AP MLD. In the association request frame, the transmitter address (TA) field is set to the MAC address of non-AP STA 1 and the receiver address (RA) field is set to the MAC address of AP 1. The association request frame includes a basic multi-link element that indicates the MLD MAC address of the non-AP MLD and complete information of non-AP STA 1, non-AP STA 2, and non-AP STA 3. The association request frame may request the setup of three links between the non-AP MLD and the AP MLD (a link between AP 1 and non-AP STA 1, a link between AP 2 and non-AP STA 2, and a link between AP 3 and non-AP STA 3).

The AP MLD may respond to the requested multi-link setup by AP sending an association response frame to non-AP STA 1 affiliated with the non-AP MLD. In the association response frame, the TA field is set to the MAC address of the AP 1 and the RA field is set to the MAC address of the non-AP STA 1. The association response frame includes a basic multi-link element that indicates the MLD MAC address of the AP MLD and complete information of AP 1, AP 2, and AP 3. The association response frame signals successful multi-link setup by the setup of three links between the non-AP MLD and AP MLD (link 1 between AP 1 and non-AP STA 1, link 2 between AP 2 and non-AP STA 2, and link 3 between AP 3 and non-AP STA 3).

By default, all TIDs at the non-AP MLD are mapped to all setup links for both uplink and downlink. The TID-to-link mapping mechanism allows an AP MLD and a non-AP MLD that performed or are performing multi-link setup to specify how UL and DL QoS traffic corresponding to different TIDs (e.g., between 0 and 7) may be assigned to the setup links. In a negotiated TID-to-link mapping, a TID may be mapped to a link set, which is a subset of setup links, ranging from a single setup link to all the setup links.

A setup link is defined as enabled for a non-AP MLD if at least one TID is mapped to that link either in DL or in UL, and is defined as disabled if no TIDs are mapped to that link both in DL and UL. At any point in time, a TID is always mapped to at least one setup link both in DL and UL, which means that a TID-to-link mapping change can only be valid and successful if it does not result in a TID having a mapped link set made of zero setup links.

By default, all setup links are enabled. If a link is enabled for a non-AP MLD, it may be used for the exchange of individually addressed frames, subject to the power state of the non-AP STA operating on that link. Only MSDUs or A-MSDUs with TIDs mapped to a link may be transmitted on that link in the direction (DL/UL) corresponding to the TID-to-link mapping. Individually addressed management frames and control frames may be sent on any enabled link between an affiliated STA of the non-AP MLD and a corresponding AP of the AP MLD, both in DL and UL.

If a link is disabled for a non-AP MLD, the link may not be used for the exchange of individually addressed frames between an affiliated STA of the non-AP MLD and a corresponding AP of the AP MLD.

If a TID is mapped in UL to a set of enabled links for a non-AP MLD, the non-AP MLD may use any link within this set of enabled links to transmit individually addressed MSDUs or A-MSDUs corresponding to that TID.

If a TID is mapped in DL to a set of enabled links for a non-AP MLD, the non-AP MLD may retrieve individually addressed BUs buffered at the AP MLD that are MSDUs or A-MSDUs corresponding to the TID, on any link of the set of enabled links. Conversely, the AP MLD may use any link within the set of enabled links to transmit individually addressed MSDUs or A-MSDUs corresponding to the TID, subject to the power state of the non-AP STA on each of the used link.

If the default mode is used, the non-AP MLD may retrieve BUs buffered by the AP MLD on any setup link, though the AP MLD may recommend a link.

A non-AP MLD may retrieve buffered BUs that are MMPDUs buffered at the AP MLD on any enabled link. An AP MLD may use any enabled link to transmit individually addressed bufferable management frames that are not measurement MMPDUs, subject to the power state of the non-AP STA on the used link.

If a STA affiliated with a non-AP MLD is in active mode on a link with a set of TIDs mapped for DL transmission, its associated AP affiliated with the AP MLD may transmit to the STA: MSDUs/A-MSDUs for the set of mapped TIDs for the non-AP MLD; and MMPDUs that are not measurement MMPDUs for the non-AP MLD or its affiliated STAs, unless the frames are transmitted to another STA affiliated with the same non-AP MLD and in active mode.

As mentioned above, under the default mapping mode, all TIDs are mapped to all setup links for DL and UL, and all setup links are enabled. A non-AP MLD and an AP MLD that perform multi-link setup shall operate under this mode if a TID-to-link mapping negotiation for a different mapping has not occurred, was unsuccessful, or was torn down.

In a multi-link (re)setup procedure, a non-AP MLD may initiate a TID-to-link mapping negotiation by including a TID-to-link mapping element in a (re)association request frame if an AP MLD has indicated support for TID-to-link mapping negotiation.

After receiving the (re)association request frame containing the TID-to-link mapping element, the AP MLD may reply to the (re)association request frame in according to the following rules. The AP MLD can accept the requested TID-to-link mapping indicated in the TID-to-link mapping element in the received (re)association request frame only if it accepts the multi-link (re)setup for all links on which at least one TID is requested to be mapped. In this case, the non-AP MLD does include in the (re)association response frame a TID-to-link mapping element. Otherwise, the non-AP MLD indicates rejection of the proposed TID-to-link mapping by including in the (re)association response frame a TID-to-link mapping element that suggests a preferred TID-to-link mapping.

Following a successful multi-link (re)setup, to negotiate a new TID-to-link mapping, an initiating MLD may send an individually addressed TID-to-link mapping request frame to a responding MLD that has indicated support of TID-to-link mapping negotiation.

On receiving the individually addressed TID-to-link mapping request frame, the responding MLD sends an individually addressed TID-to-link mapping response frame to the initiating MLD according to the following rules. The responding MLD may accept the requested TID-to-link mapping indicated in the TID-to-link mapping element in the received TID-to-link mapping request frame by transmitting a TID-to-link mapping response frame. Otherwise, the responding MLD may indicate rejection of the proposed TID-to-link mapping in the TID-to-link mapping response frame. The responding MLD may suggest a preferred TID-to-link mapping in the TID-to-link mapping response frame by including the TID-to-link mapping element in the TID-to-link mapping response frame.

An MLD may suggest a preferred TID-to-link mapping to a peer MLD by sending an unsolicited TID-to-link mapping response frame that includes a TID-to-link mapping element.

When a peer MLD indicates a preferred TID-to-link mapping, an MLD may take into account the preferred TID-to-link mapping when it initiates a new TID-to-link mapping. In addition, an AP MLD may take into account the traffic flow(s) affiliated with the non-AP MLD and the capabilities and constraints (if any) of the non-AP MLD.

When two MLDs have negotiated a TID-to-link mapping, either MLD may tear down the negotiated TID-to-link mapping by sending an individually addressed TID-to-link mapping teardown frame. After teardown, the MLDs operates in default mapping mode.

When an MLD successfully negotiates a TID-to-link mapping with a peer MLD, both the MLD and the peer MLD update an uplink and/or downlink TID-to-link mapping information according to the negotiated the TID-to-link mapping.

When an MLD has successfully negotiated with a peer MLD an uplink and/or downlink TID-to-link mapping in which the bit position i of a link mapping field n in the TID-to-link mapping element is set to 0, a TID n shall not be mapped to the link associated with the link ID i in uplink and/or downlink. When an MLD has successfully negotiated with a peer MLD an uplink and/or downlink TID-to-link mapping in which the bit position i of a link mapping field n in the TID-to-link mapping element is set to 1, the TID n is mapped to the link associated with the link ID i in uplink and/or downlink.

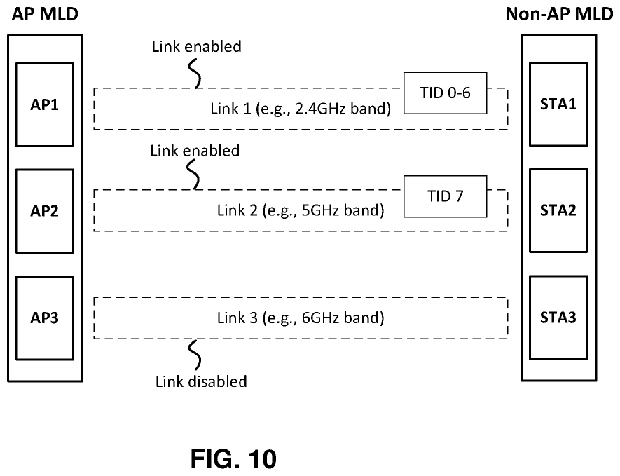

FIG. 10 illustrates an example of a TID-to-link mapping in a multi-link communication environment. As shown, the multi-link communication environment includes an AP MLD having three affiliated APs and a non-AP MLD having three affiliated STAs.

During or after multi-link setup, the non-AP MLD and the AP MLD may negotiate a TID-to-link mapping. The TID-to-link mapping maps TIDs at the non-AP MLD in UL and DL to setup links between the AP MLD and the non-AP MLD. For example, as shown in FIG. 10, the TID-to-link mapping may map TIDs 0-6 in both UL and DL to link 1 and TID 7 in both UL and DL to link 2. As such, links 1 and 2 are enabled, and link 3 is disabled. The TID-to-link mapping negotiation may be performed by exchanging an association request/response frame or a TID-to-link mapping request/response frame between the non-AP MLD and the AP MLD.

It is envisioned that future IEEE 802.11 devices may support communication over extremely high frequency (EHF) links. The EHF links may include links comprised in the millimeter wave (mmWave) band (e.g. a band of RF frequencies from 30 to 300 GHz). For example, the EHF links are anticipated to include 60 GHz links (e.g., links in the frequency range of 57 to 71 GHz). While the communication range over EHF links may be lower than non-EHF links (e.g., 2.4, 5, and 6 GHz), it is expected that EHF links support greater bandwidths than non-EHF links and may thus be better suited than non-EHF links for low latency and wide bandwidth communications.

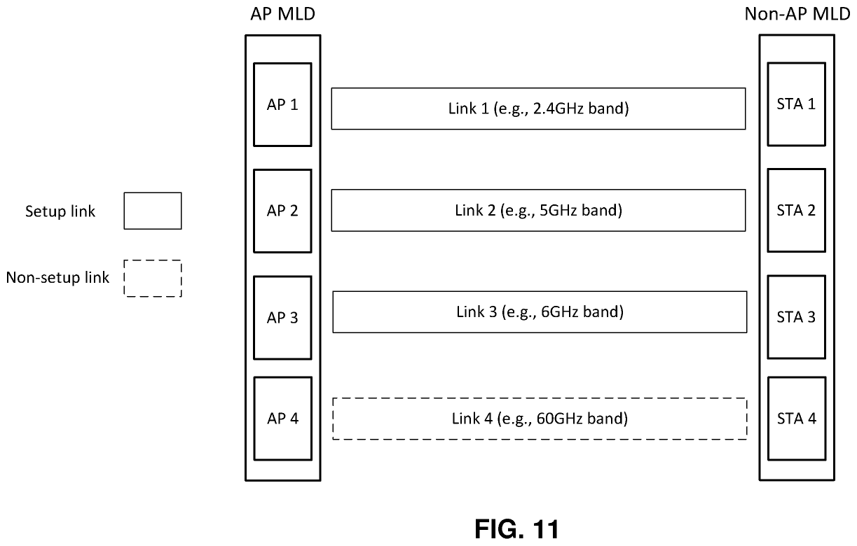

FIG. 11 illustrates an example multi-link configuration, between an AP MLD and a non-AP MLD, that includes an EHF link. As shown, the AP MLD has four affiliated APs: AP 1 operating in the 2.4 GHz band, AP 2 operating in the 5 GHz band, AP 3 operating in the 6 GHz band, and AP 4 operating in the 60 GHz band. The non-AP MLD has four affiliated STAs: non-AP STA 1 operating in the 2.4 GHz band, non-AP STA 2 operating in the 5 GHz band, non-AP STA 3 operating in the 6 GHz band, and non-AP STA 4 operating in the 60 GHz band.

The non-AP MLD may perform a multi-link (re)setup (as described above with reference to FIG. 9) to (re)setup multiple links with AP MLD. After successful multi-link (re)setup between the non-AP MLD and the AP MLD, the non-AP MLD becomes associated with the AP MLD and multiple links are set up between the non-AP MLD and the AP MLD. More specifically, for each setup link, the corresponding non-AP STA affiliated with the non-AP MLD becomes associated with the corresponding AP affiliated with the AP MLD. For example, in FIG. 11, the AP MLD may perform a multi-link (re)setup to set up multiple links from among a plurality of links, comprising a first link (link 1), a second link (link 2), a third link (link 3), and a fourth link (link 4). In an example, link 1, link 2, link 3, and link 4 may correspond respectively to a 2.4 GHz link, a 5 GHz link, a 6 GHz link, and a 60 GHz link. The 2.4 GHz, 5 GHz, and 6 GHz links are non-EHF links, and the 60 GHz link is an EHF link. At the end of the multi-link (re)setup, the non-AP MLD is associated with the AP MLD and links 1, 2, and 3 are setup between non-AP MLD and AP MLD. Specifically, non-AP STA 1 is associated with AP 1, non-AP STA 2 is associated with AP 2, and non-AP STA 3 is associated with AP 3.

In an example, the non-AP MLD may request the setup of links 1, 2, and 3 in the multi-link (re)setup and the AP MLD may accept the request resulting in the setup of links 1, 2, and 3. In another example, the non-AP MLD may request the setup of links 1, 2, 3, and 4 and the AP MLD may accept the setup of links 1, 2, and 3 but not of link 4. Link 4 may thus remain not setup as shown in FIG. 11. Setup links may then be enabled by mapping to each one or more TIDs as described above with reference to FIG. 10.

In an example, the non-AP MLD may request the setup of link 4 with the AP MLD after performing the (re)setup that results in the setup of links 1, 2, and 3 as shown in FIG. 11. In an implementation, the non-AP MLD may request link reconfiguration of the ML setup by sending a Link Reconfiguration Request frame to the AP MLD. The non-AP MLD may send the Link Reconfiguration Request frame from an affiliated non-AP STA to the corresponding AP affiliated with the AP MLD. To indicate support of link reconfiguration, the AP MLD may set a Link Reconfiguration Operation Support subfield to 1 in an MLD Capabilities And Operations subfield of a Basic Multi-Link element that the AP MLD transmits. The Link Reconfiguration Request frame may contain a Reconfiguration Multi-Link element that includes a Per-STA Profile subelement for each affiliated non-AP STA that the non-AP MLD is requesting to add to its ML setup or delete from its ML setup. For example, in FIG. 11, a Reconfiguration Multi-Link

element included in the Link Reconfiguration Request frame from the non-AP MLD may include a Per-STA Profile subelement for non-AP STA 4. The Per-STA Profile subelement for non-AP STA 4 may include, for example, a Link ID subfield set to a link identifier of AP 4 operating on link 4 that the non-AP MLD is requesting to add; an NSTR (non-simultaneous transmit and receive) Indication Bitmap Present bit set to 1 if at least one NSTR link pair that includes link 4 is present for the non-AP MLD; a STA MAC Address subfield in a STA Info field set to the STA MAC address of non-AP STA 4; and a STA Profile field that includes a complete profile for non-AP STA 4.

After receiving the Link Reconfiguration Request frame from the non-AP MLD, the AP MLD may respond with a Link Reconfiguration Response frame. The AP MLD may validate an OCI element included in the Link Reconfiguration Request frame before sending the Link Reconfiguration Response frame to the non-AP MLD. The AP MLD may send the Link Reconfiguration Response frame via the same link on which the AP MLD receives the Link Reconfiguration Request frame. If the AP MLD accepts link addition for one or more links, the AP MLD may include in the Link Reconfiguration Response frame a Basic Multi-Link element that includes a Per-STA Profile subelement for each AP operating on a link that is accepted by the AP MLD for addition to the ML setup of the non-AP MLD. For example, in FIG. 11, if the AP MLD accepts the addition of link 4, the AP MLD may include in the Link Reconfiguration Response frame a Basic Multi-Link element that include a Per-STA Profile subelement for AP 4.

After sending a Link Reconfiguration Response frame to the non-AP MLD indicating SUCCESS status for an add link operation and receiving an acknowledgement for the response frame from the non-AP MLD, the AP MLD shall consider that link to be added to the ML setup of the associated non-AP MLD.

The AP MLD may reject a request to add a link if any of the following conditions is true:
The non-AP STA affiliated with the non-AP MLD corresponding to the link does not support all of the rates in the BSSBasicRateSet parameter and all of the membership selectors in the BSSMembershipSelectorSet parameter of the AP affiliated with the AP MLD corresponding to the link in the MLME-START. request primitive.
The non-AP STA affiliated with the non-AP MLD corresponding to the link does not support all of the MCSs in the Basic HT-MCS Set field of the HT Operation parameter of the AP affiliated with the AP MLD (if present) corresponding to the link in the MLME-START. request primitive.
The non-AP STA affiliated with the non-AP MLD corresponding to the link does not support all of the <VHT-MCS, NSS> tuples indicated by the Basic VHT-MCS And NSS Set field of the VHT Operation parameter of the AP affiliated with the AP MLD (if present) corresponding to the link in the MLME-START. request primitive.
The non-AP STA affiliated with the non-AP MLD corresponding to the link does not support all of the <HE-MCS, NSS> tuples indicated by the Basic HE-MCS And NSS Set field of the HE Operation parameter of the AP affiliated with the AP MLD corresponding to the link in the MLME-START. request primitive.
The non-AP STA affiliated with the non-AP MLD corresponding to the link does not support all of the <EHT-MCS, NSS> tuples indicated by the Basic EHT-MCS And NSS Set field of the EHT Operation parameter of the AP affiliated with the AP MLD corresponding to the link in the MLME-START. request primitive.
If the non-AP STA affiliated with the non-AP MLD corresponding to that link has the same MAC address as a non-AP STA (that is affiliated with a non-AP MLD or not affiliated with a non-AP MLD) associated with the AP affiliated with the AP MLD corresponding to the link.

The non-AP MLD may discover the AP MLD and its affiliated APs (including an affiliated AP operating on an EHF link) when a non-AP STA affiliated with the non-AP MLD receives one or more of the following:
a Basic Multi-Link element carried in a Beacon frame or Probe Response frame, that is not a multi-link probe response, transmitted by an AP affiliated with the AP MLD or by the AP corresponding to the transmitted BSSID in the same multiple BSSID set as at least one of the APs affiliated with the AP MLD.
a multi-link probe response from an AP affiliated with the AP MLD or the AP corresponding to the transmitted BSSID in the same multiple BSSID set as at least one of the APs affiliated with the AP MLD carrying a Basic Multi-Link element with a complete profile of one or more reported APs.
one or more of Beacon, Probe Response or FILS Discovery frame transmitted by an AP (reporting AP) and the frame carries a Reduced Neighbor Report element that includes the MLD Parameters subfield in the TBTT Information field corresponding to one or more reported APs. A non-AP MLD infers the relationship between the reported AP(s) and the reporting AP by decoding the AP MLD ID subfield of the MLD Parameters subfield in the Reduced Neighbor Report element and following the rules described in 35.3.4.1 (AP behavior).
a management frame that carries a Neighbor Report element. A non-AP MLD determines that two or more APs reported in different Neighbor Report elements that include the Basic Multi-Link subelement are affiliated with the same AP MLD based on the MLD MAC Address subfield of the Common Info field of the Basic Multi-Link

elements. The reported APs are affiliated with the same AP MLD if the values carried in MLD MAC Address field of the Common Info field of the Basic Multi-Link element of the reported APs are the same.

The non-AP MLD may use the information it gathers from a Reduced Neighbor Report element, a Neighbor Report element, or a Basic Multi-Link element to decide whether to perform ML setup with an AP MLD.

While the non-AP MLD may be able to discover that the AP MLD supports an EHF link, the non-AP MLD may further need to determine whether it can reach the AP MLD via the EHF link so as to communicate with the AP MLD via the EHF link. In one approach, the AP MLD may be configured to transmit a beacon frame over the EHF link. The beacon frame may be referred to as a “light beacon.” The AP MLD may transmit the light beacon periodically. In an implementation, the light beacon may be used by the non-AP MLD for EHF link reachability decisions. That is, the non-AP MLD may determine whether it can reach the AP MLD via the EHF link based on whether the non-AP MLD may detect the light beacon (e.g., with a SNR above a threshold). The light beacon may or may not be used for association between the AP MLD and the non-AP MLD. The light beacon may or may not be used for BSS management.

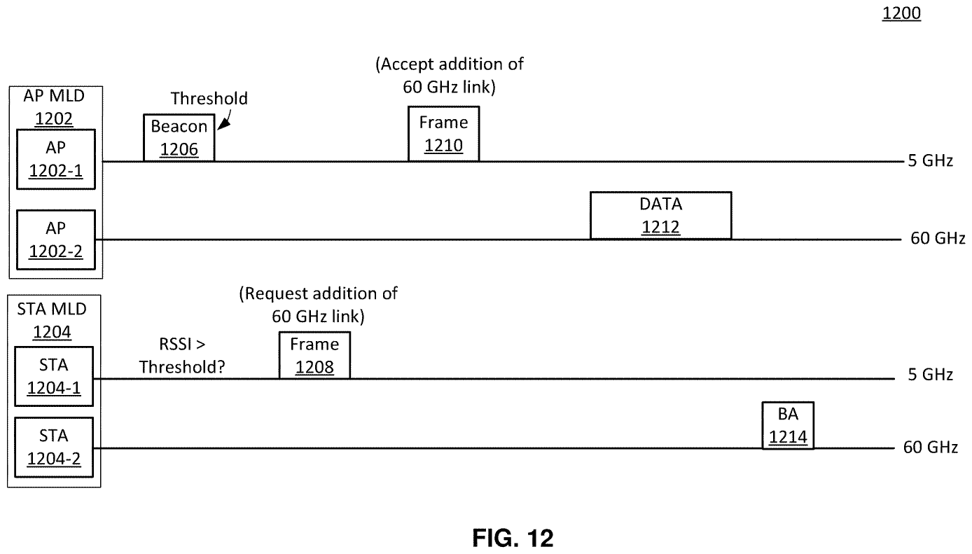

In another approach, rather than using a beacon frame on the EHF link, EHF link reachability may be based on signal strength over one or more non-EHF links. FIG. 12 illustrates an example 1200 of an EHF link setup procedure based on signal strength associated with a non-EHF link. As shown in FIG. 12, example 1200 includes an AP MLD 1202 and a STA MLD (or non-AP MLD) 1204. AP MLD 1202 has two affiliated APs: AP 1202-1 operating in the 5 GHz band and AP 1202-2 operating in the 60 GHz band. STA MLD 1204 has two affiliated STAs (or non-AP STAs): STA 1204-1 operating in the 5 GHz band and STA 1204-2 operating in the 60 GHz band.

In example 1200, STA MLD 1204 may perform a multi-link (re)setup (as described above with reference to FIG. 9) that results in the setup of a non-EHF link in the 5 GHz band between AP MLD 1202 and STA MLD 1204. At the end of the multi-link (re)setup, STA MLD 1204 becomes associated with AP MLD 1202. Specifically, STA 1204-1 affiliated with STA MLD 1204 becomes associated with AP 1202-1 affiliated with AP MLD 1202.

In accordance with the EHF link setup procedure of FIG. 12, STA MLD 1204 may be configured to receive a beacon (or other) frame via the non-EHF link from AP MLD 1202, compare a received signal strength indicator (RSSI) of the beacon frame with a threshold, and determine, based on the comparison, whether it may set up an EHF link with AP MLD 1202. Specifically, in an implementation, STA MLD 1204 may be configured to determine that it may set up the EHF link with AP MLD 1202 when the RSSI of the beacon frame is greater than the threshold. In an implementation, STA MLD 1204 may be configured to determine that it may not set up the EHF link with AP MLD 1202 when the RSSI of the beacon frame is not greater than the threshold. That is, it may be assumed that STA MLD 1204 may reach AP MLD 1202 via the EHF link when the RSSI of the beacon frame via the non-EHF link is greater than the threshold.

For example, as shown in FIG. 12, STA MLD 1204 may receive, via STA 1204-1 over the non-EHF link (5 GHz link), a beacon frame 1206 transmitted by AP MLD 1202, via AP 1202-1. STA MLD 1204 may determine an RSSI of beacon frame 1206 and may compare the RSSI of beacon frame 1206 to a threshold. The threshold may be pre-configured or may be indicated in beacon frame 1206. In example 1200, it assumed that the RSSI of beacon frame 1206 is greater than the threshold. As such, STA MLD 1204 may determine that it may set up the EHF link (60 GHz link) with AP MLD 1202.

In example 1200, based on determining that it may set up the EHF link with AP MLD 1202, STA MLD 1204 may decide to set up the EHF link with AP MLD 1202. In an implementation, STA MLD 1204 may transmit a frame 1208 (e.g., via the non-EHF link) comprising a request to add the EHF link with AP MLD 1202. Frame 1208 may comprise a Link Reconfiguration Request frame as described above. Assuming that the conditions for adding the EHF link are met (as described above), AP MLD 1202 may accept the request of STA MLD 1204 to add the EHF link. In an implementation, AP MLD 1202 may transmit a frame 1210 accepting the request to add the EHF link with STA MLD 1204. Frame 1210 may comprise a Link Reconfiguration Response frame as described above. In an implementation, STA MLD 1204 may send an acknowledgement (not shown in FIG. 12) to AP MLD 1202 in response to frame 1210. On receiving the acknowledgement, AP MLD 1202 may consider the EHF link (60 GHz link) added to the ML setup of STA MLD 1204, and STA 1204-2 becomes associated with AP 1202-2. In an example, AP MLD 1202 may use the EHF link to transmit to STA MLD 1204 a data frame 1212, which STA MLD 1204 may acknowledge by transmitting a BA frame 1214 to AP MLD 1202.

The EHF link setup procedure of FIG. 12 may in some cases, however, excessively limit the ability of the non-AP MLD to utilize the EHF link. For example, due to inaccurate threshold setting and/or changes in the environment, the non-AP MLD may be unnecessarily prohibited from adding the EHF link (due to the RSSI measured on the non-EHF link being not greater than the threshold). This may occur despite the non-AP MLD being, in fact, able to reach the AP MLD via the EHF link.

Embodiments of the present disclosure, as further discussed, address this problem. In one aspect, a STA may be configured to receive from an AP a beacon frame via a first link. The first link may be a non-EHF link. Based on an RSSI of the beacon frame being less than or equal to a threshold, the STA may be configured to attempt to detect a second frame transmitted by the AP via a second link. The second link may be an EHF link. Based on detecting the second frame, the STA may be configured to transmit to the AP a third frame comprising a request to establish (or add) the second link between the STA and the AP. The second frame may be a frame transmitted by the AP to another STA via the second link. Based on the RSSI of the beacon frame being greater than the threshold, the STA may be configured to transmit a fourth frame comprising a request to establish (or add) the second link between the STA and the AP.

In another aspect, the AP may be configured to receive from the STA a first frame via the first link and to transmit to the STA a second frame indicating a link establishment status of the STA based on the first frame. The first link may be an EHF link. The link establishment status of the STA may comprise an establishment status of the first link. The link establishment status of the STA, based on the first frame, may be based on an RSSI of the first frame at the AP. In an embodiment, the establishment status of the first link indicates that the first link is established between the STA and the AP based on the RSSI of the first frame being greater than a threshold. In an embodiment, the establishment status of the first link indicates that the first link is not established between the STA and the AP based on the RSSI of the first frame being lower than or equal to a threshold.

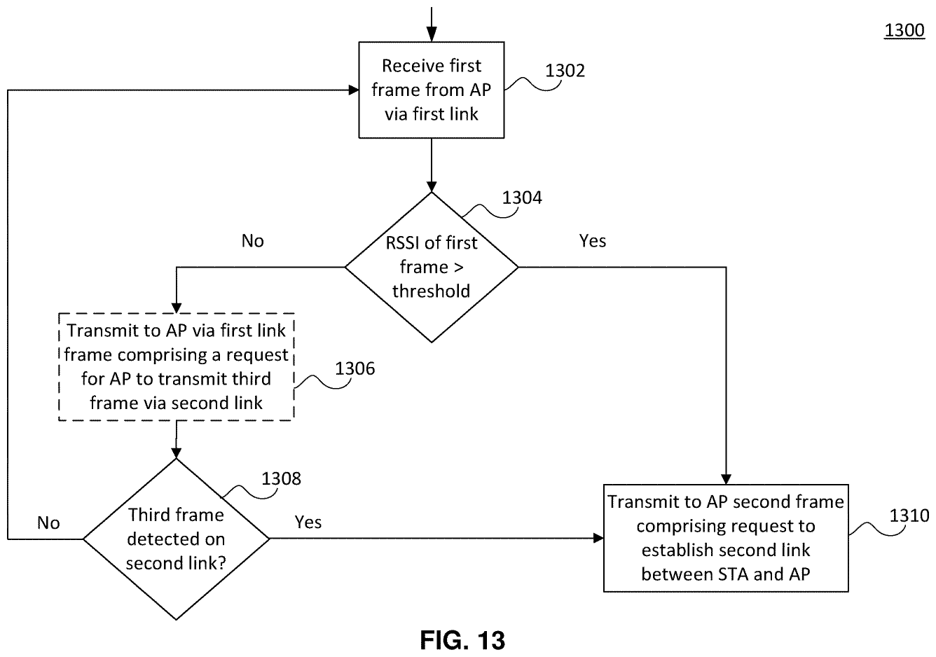

FIG. 13 illustrates an example link setup process 1300 according to an embodiment. Link setup process 1300 is provided for the purpose of illustration only and is not limiting of embodiments of the present disclosure. Link setup process 1300 may be used by a STA to add an EHF link to a multi-link (ML) setup with an AP. The STA may be a STA MLD (or non-AP MLD). The STA may be associated with the AP via a first link of the multi-link setup. The first link may be a non-EHF link (e.g., 2.4, 5, or 6 GHz link). The STA and the AP may support operation over a second link. The second link may be an EHF link (e.g., 60 GHz link).

As shown in FIG. 13, process 1300 begins in step 1302, which includes receiving a first frame from the AP via the first link. The first frame may comprise a beacon frame or an action frame.

Next, step 1304 includes determining whether an RSSI of the first frame is greater than a threshold. The threshold may be pre-configured or indicated in the first frame or another frame. The threshold may be based on a carrier sense threshold associated with the first link. In an implementation, the carrier sense threshold may be based on a minimum modulation and coding rate sensitivity for the first link. In an example implementation, the carrier sense threshold associated with the first link may be equal to −82 dBm, −72 dBm, or −62 dBm. In an embodiment, the threshold may be set to be greater than or equal to the carrier sense threshold associated with the first link.

If the answer in step 1304 is yes, process 1300 transitions to step 1310, which includes transmitting to the AP a second frame comprising a request to establish or add the second link between the STA and the AP. The second frame may be transmitted via the first link or the second link.

In an embodiment, the request to establish the second link between the STA and the AP comprises a request to add the second link to the ML setup between the AP and STA. In an implementation, the second frame may comprise a Link Reconfiguration Request frame as described above. In an implementation, the second frame may comprise a Reconfiguration Multi-Link element as described above. The AP may respond to the second frame by transmitting a Link Reconfiguration Response frame as described above.

In another embodiment, process 1300 may comprise performing by the STA a multi-link setup process comprising the second link. Step 1310 may be, as such, a part of the multi-link setup process. In an implementation, the second frame may comprise a basic ML element comprising link information of the second link. In an implementation, the second frame may be a (re)association request frame. The AP may respond to the second frame by transmitting a (re)association response frame as described above.

In another embodiment, the AP may respond to the second frame by transmitting a beacon frame indicating a link establishment status of the STA. The link establishment status of the STA may indicate whether the second link is established (or added) between the STA and the AP. In an implementation, the beacon frame comprises an information element that comprises the link establishment status of the STA.

In an embodiment, process 1300 may further comprise mapping a TID to the second link. In an embodiment, the second frame may comprise a request to map the second link to the TID. In an embodiment, the second frame may comprise a TID-to-Link mapping request frame.

If the answer in step 1304 is no, process 1300 transitions to step 1308, which includes determining whether a third frame from the AP is detected on the second link. The third frame may be transmitted by the AP to the STA or to another STA. The third frame may be a data frame or a control frame. In an example implementation, the third frame may be a CTS-to-self frame.

In an embodiment, detecting the third frame comprises detecting a preamble of a PPDU carrying the third frame. The PPDU may comprise a BSS color field indicating a BSS color value associated with the AP or a transmit address field indicating an address of the AP. In another embodiment, detecting the third frame may further comprise detecting an uplink/downlink (UL/DL) field of the PPDU indicating that the PPDU is a DL PPDU.

In an embodiment, as shown in FIG. 13, process 1300 may optionally include a step 1306 before step 1308. That is, the STA may perform step 1306 before performing step 1308. Step 1306 includes transmitting to the AP via the first link a frame comprising a request for the AP to transmit the third frame via the second link. The frame transmitted in step 1306 may comprise an action frame or a QoS null frame, for example. The AP may respond to the frame transmitted in step 1306 by transmitting the third frame.

If the answer in step 1308 is no, process 1300 return to step 1302 described above. Otherwise, process 1300 transitions to step 1310 described above.

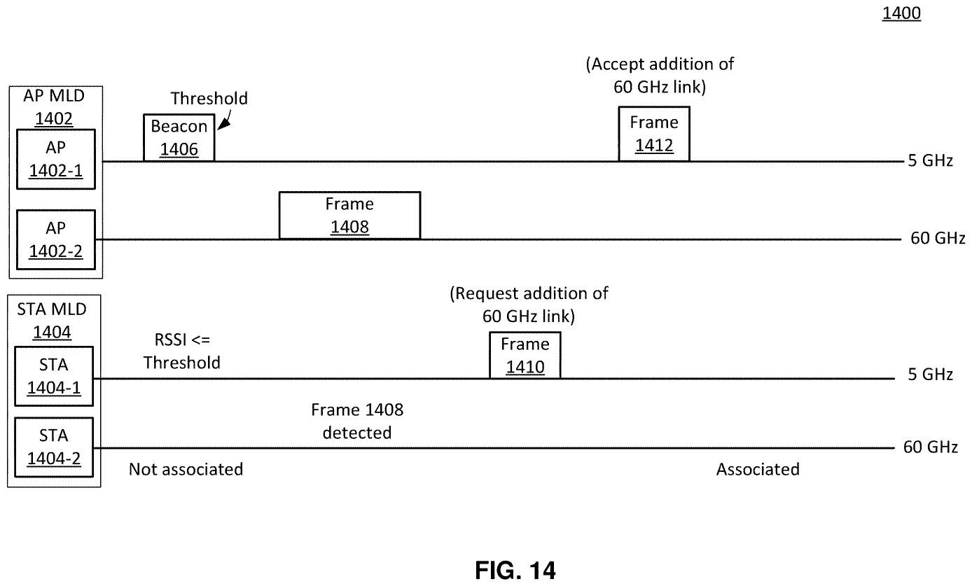

FIG. 14 illustrates an example 1400 of the link setup process illustrated in FIG. 13. Example 1400 is provided for the purpose of illustration only and is not limiting of embodiments of the present disclosure. As shown in FIG. 14, example 1400 includes an AP MLD 1402 and a STA MLD (or non-AP MLD) 1404. AP MLD 1402 has two affiliated APs: AP 1402-1 operating in the 5 GHz band and AP 1402-2 operating in the 60 GHz band. STA MLD 1404 has two affiliated STAs (or non-AP STAs): STA 1404-1 operating in the 5 GHz band and STA 1404-2 operating in the 60 GHz band.

In example 1400, STA MLD 1404 may perform a multi-link (re)setup (as described above with reference to FIG. 9) that results in the setup of a non-EHF link in the 5 GHz band between AP MLD 1402 and STA MLD 1404. At the end of the multi-link (re)setup, STA MLD 1404 becomes associated with AP MLD 1402. Specifically, STA 1404-1 affiliated with STA MLD 1404 becomes associated with AP 1402-1 affiliated with AP MLD 1402.

STA MLD 1404 may be configured to perform the link setup process illustrated in FIG. 13 to establish or add an EHF link with AP MLD 1402. Specifically, STA MLD 1404 may be configured to receive a beacon (or other) frame via the non-EHF link from AP MLD 1402, compare an RSSI of the beacon frame with a threshold, and determine, based on the comparison, respective operations to set up the EHF link with AP MLD 1402. Specifically, in an embodiment, when the RSSI of the beacon frame is not greater than the threshold, STA MLD 1404 may be configured to determine that it may set up the EHF link with AP MLD 1402 on the condition of detecting a frame from AP MLD 1402 via the EHF link. On the other hand, when the RSSI of the beacon frame is greater than the threshold, STA MLD 1404 may be configured to determine that it may set up the EHF link with AP MLD 1402, without having to first detect a frame from AP MLD 1402 via the EHF link.

For example, as shown in FIG. 14, STA MLD 1404 may receive, via STA 1404-1 over the non-EHF link (5 GHz link), a beacon frame 1406 transmitted by AP MLD 1402, via AP 1402-1. STA MLD 1404 may determine an RSSI of beacon frame 1406 and may compare the RSSI of beacon frame 1406 to a threshold. The threshold may be pre-configured or may be indicated in beacon frame 1406.

In example 1400, for the purpose of illustration, it assumed that the RSSI of beacon frame 1406 is not greater than the threshold. As such, STA MLD 1404 may determine that it may set up the EHF link (60 GHz link) with AP MLD 1402 on condition of detecting a frame from AP MLD 1402 via the EHF link.

Based on determining that it may set up the EHF link with AP MLD 1402 based on detecting a frame from AP MLD 1402 via the EHF link, STA MLD 1404 may attempt to detect a frame from AP MLD 1402 via the EHF link. In an embodiment, detecting a frame from the AP comprises detecting a preamble of a PPDU carrying the frame. The PPDU may comprise a BSS color field indicating a BSS color value associated with the AP or a transmit address field indicating an address of the AP. In another embodiment, detecting the frame from the AP may further comprise detecting an uplink/downlink (UL/DL) field of the PPDU indicating that the PPDU is a DL PPDU.

In example 1400, it is assumed that AP MLD 1402 transmits a frame 1408 via the EHF link after transmitting beacon frame 1406. Frame 1408 may be transmitted to another STA for example. Frame 1408 may be a data frame or a control frame. It assumed, for the purpose of illustration, that STA MLD 1404 detects frame 1408.

Based on detecting frame 1408 from AP MLD 1402, STA MLD 1404 may transmit a frame 1410 (e.g., via the non-EHF link) comprising a request to add the EHF link with AP MLD 1402. Frame 1410 may comprise a Link Reconfiguration Request frame as described above. In an embodiment, frame 1410 may comprise an indication of detection by STA MLD 1404 of a frame (e.g., frame 1408) transmitted by AP MLD 1402 via the EHF link. Assuming that the conditions for adding the EHF link are met (as described above), AP MLD 1402 may accept the request of

STA MLD 1404 to add the EHF link. In an implementation, AP MLD 1402 may transmit a frame 1412 accepting the request to add the EHF link with STA MLD 1404. Frame 1412 may comprise a Link Reconfiguration Response frame as described above. In an implementation, STA MLD 1404 may send an acknowledgement (not shown in FIG. 14) to AP MLD 1402 in response to frame 1412. On receiving the acknowledgement, AP MLD 1402 may consider the EHF link (60 GHz link) added to the ML setup of STA MLD 1404, and STA 1404-2 becomes associated with AP 1402-2.

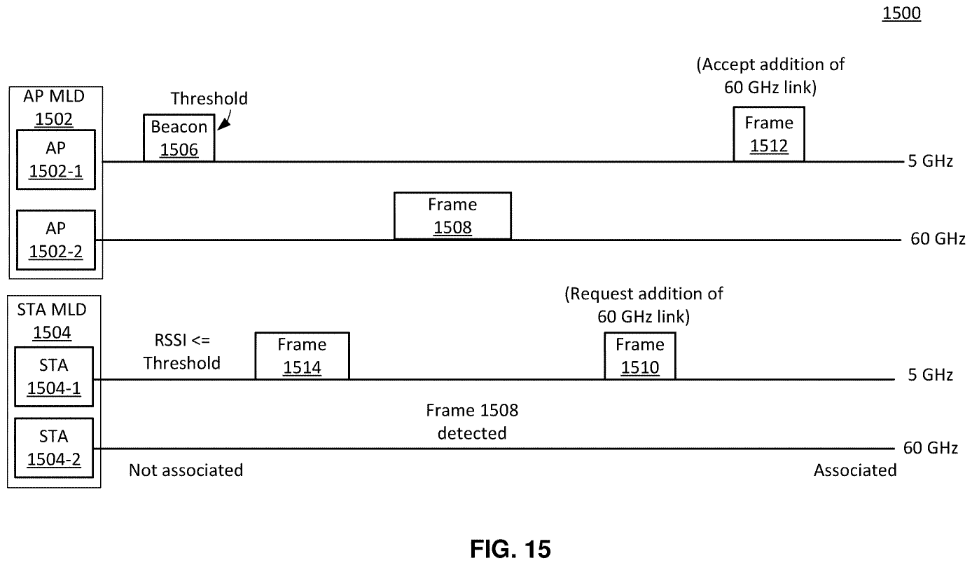

FIG. 15 illustrates another example 1500 of the link setup process illustrated in FIG. 13. Example 1500 is provided for the purpose of illustration only and is not limiting of embodiments of the present disclosure. As shown in FIG. 15, example 1500 includes an AP MLD 1502 and a STA MLD (or non-AP MLD) 1504. AP MLD 1502 has two affiliated APs: AP 1502-1 operating in the 5 GHz band and AP 1502-2 operating in the 60 GHz band. STA MLD 1504 has two affiliated STAs (or non-AP STAs): STA 1504-1 operating in the 5 GHz band and STA 1504-2 operating in the 60 GHz band.

In example 1500, STA MLD 1504 may perform a multi-link (re)setup (as described above with reference to FIG. 9) that results in the setup of a non-EHF link in the 5 GHz band between AP MLD 1502 and STA MLD 1504. At the end of the multi-link (re)setup, STA MLD 1504 becomes associated with AP MLD 1502. Specifically, STA 1504-1 affiliated with STA MLD 1504 becomes associated with AP 1502-1 affiliated with AP MLD 1502.

STA MLD 1504 may be configured to perform the link setup process illustrated in FIG. 13 (including optional step 1306) to establish or add an EHF link with AP MLD 1502. Specifically, STA MLD 1504 may be configured to receive a beacon (or other) frame via the non-EHF link from AP MLD 1502, compare an RSSI of the beacon frame with a threshold, and determine, based on the comparison, respective operations to set up the EHF link with AP MLD 1502. Specifically, in an embodiment, when the RSSI of the beacon frame is not greater than the threshold,

STA MLD 1504 may be configured to determine that it may set up the EHF link with AP MLD 1502 on the condition of detecting a frame from AP MLD 1502 via the EHF link. On the other hand, when the RSSI of the beacon frame is greater than the threshold, STA MLD 1504 may be configured to determine that it may set up the EHF link with AP

MLD 1502, without having to first detect a frame from AP MLD 1502 via the EHF link. In an embodiment, STA MLD 1504 may further be configured to transmit to AP MLD 1502 via the non-EHF link a frame requesting the transmission by AP MLD 1502 of the frame via the EHF link for detection by STA MLD 1504. In response to the frame from STA MLD 1504, AP MLD 1502 may be configured to transmit the frame via the EHF link for detection by STA MLD 1504.

For example, as shown in FIG. 15, STA MLD 1504 may receive, via STA 1504-1 over the non-EHF link (5 GHz link), a beacon frame 1506 transmitted by AP MLD 1502, via AP 1502-1. STA MLD 1504 may determine an RSSI of beacon frame 1506 and may compare the RSSI of beacon frame 1506 to a threshold. The threshold may be pre-configured or may be indicated in beacon frame 1506.

In example 1500, for the purpose of illustration, it assumed that the RSSI of beacon frame 1506 is not greater than the threshold. As such, STA MLD 1504 may determine that it may set up the EHF link (60 GHz link) with AP MLD 1502 on condition of detecting a frame from AP MLD 1502 via the EHF link.

Based on determining that it may set up the EHF link with AP MLD 1502 based on detecting a frame from AP MLD 1502 via the EHF link, STA MLD 1504 may transmit a frame 1514 to AP MLD 1502 comprising a request for AP MLD 1502 to transmit the frame via the EHF link for detection by STA MLD 1504. Frame 1514 may be transmitted via the non-EHF link or the EHF link. Frame 1514 may be an action frame or a QoS null frame, for example.

On receiving frame 1514 from STA MLD 1504, AP MLD 1502 may transmit a frame 1508 via the EHF link. Frame 1508 may be a beacon frame (e.g., light beacon) or a probe response frame, for example.

It assumed, for the purpose of illustration, that STA MLD 1504 detects frame 1508. In an embodiment, detecting a frame from the AP comprises detecting a preamble of a PPDU carrying the frame. The PPDU may comprise a BSS color field indicating a BSS color value associated with the AP or a transmit address field indicating an address of the AP. In another embodiment, detecting the frame from the AP may further comprise detecting an uplink/downlink (UL/DL) field of the PPDU indicating that the PPDU is a DL PPDU.

Based on detecting frame 1508 from AP MLD 1502, STA MLD 1504 may transmit a frame 1510 (e.g., via the non-EHF link) comprising a request to add the EHF link with AP MLD 1502. Frame 1510 may comprise a Link Reconfiguration Request frame as described above. In an embodiment, frame 1510 may comprise an indication of detection by STA MLD 1504 of a frame (e.g., frame 1508) transmitted by AP MLD 1502 via the EHF link. Assuming that the conditions for adding the EHF link are met (as described above), AP MLD 1502 may accept the request of STA MLD 1504 to add the EHF link. In an implementation, AP MLD 1502 may transmit a frame 1512 accepting the request to add the EHF link with STA MLD 1504. Frame 1512 may comprise a Link Reconfiguration Response frame as described above. In an implementation, STA MLD 1504 may send an acknowledgement (not shown in FIG. 15) to AP MLD 1502 in response to frame 1512. On receiving the acknowledgement, AP MLD 1502 may consider the EHF link (60 GHz link) added to the ML setup of STA MLD 1504, and STA 1504-2 becomes associated with AP 1502-2.

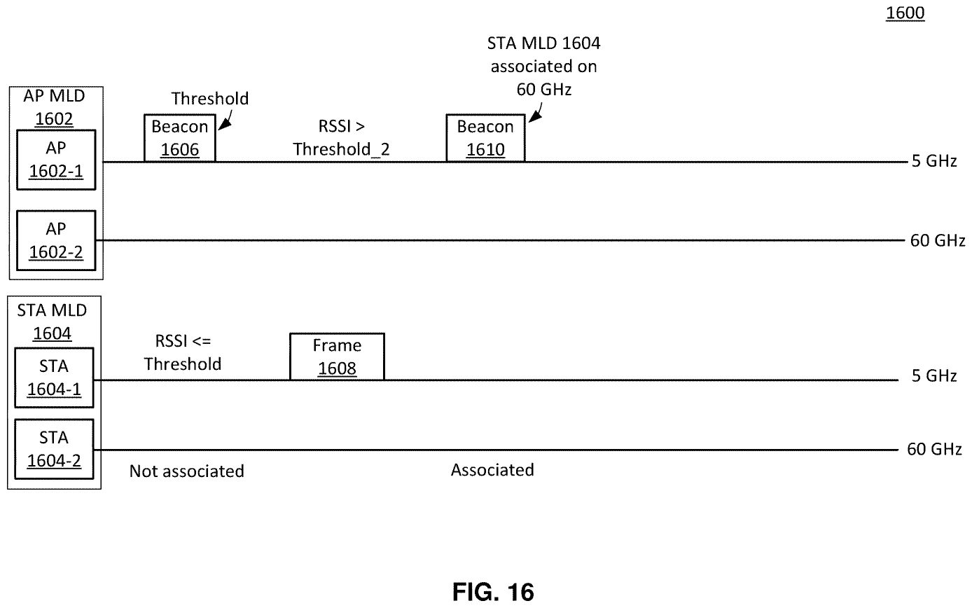

FIG. 16 illustrates an example 1600 of another link setup process according to an embodiment. Example 1600 is provided for the purpose of illustration only and is not limiting of embodiments of the present disclosure. As shown in FIG. 16, example 1600 includes an AP MLD 1602 and a STA MLD (or non-AP MLD) 1604. AP MLD 1602 has two affiliated APs: AP 1602-1 operating in the 5 GHz band and AP 1602-2 operating in the 60 GHz band. STA MLD 1604 has two affiliated STAs (or non-AP STAs): STA 1604-1 operating in the 5 GHz band and STA 1604-2 operating in the 60 GHz band.

In example 1600, STA MLD 1604 may perform a multi-link (re)setup (as described above with reference to FIG. 9) that results in the setup of a non-EHF link in the 5 GHz band between AP MLD 1602 and STA MLD 1604. At the end of the multi-link (re)setup, STA MLD 1604 becomes associated with AP MLD 1602. Specifically, STA 1604-1 affiliated with STA MLD 1604 becomes associated with AP 1602-1 affiliated with AP MLD 1602.

In accordance with the link setup process of FIG. 16, STA MLD 1604 may be configured to receive a beacon (or other) frame via the non-EHF link from AP MLD 1602, compare an RSSI of the beacon frame with a threshold, and determine, based on the comparison, respective operations to set up the EHF link with AP MLD 1602. Specifically, in an embodiment, when the RSSI of the beacon frame is not greater than the threshold, STA MLD 1604 may be configured to determine that it may set up the EHF link with AP MLD 1602 on the condition of detecting a frame from AP MLD 1602 via the EHF link. On the other hand, when the RSSI of the beacon frame is greater than the threshold, STA MLD 1604 may be configured to determine that it may set up the EHF link with AP MLD 1602, without having to first detect a frame from AP MLD 1602 via the EHF link. In an embodiment, STA MLD 1604 may further be configured to transmit via the non-EHF link a frame to AP MLD 1602 requesting the transmission by AP MLD 1602 of the frame via the EHF link for detection by STA MLD 1604. In an embodiment, STA MLD 1604 may be configured to attempt to detect the frame transmitted by AP MLD 1602 via the EHF link. Based on detecting the frame transmitted by AP MLD 1602 via the EHF link, STA MLD 1604 may be configured to transmit to AP MLD 1602 a frame requesting the addition of the EHF link. In another embodiment, STA MLD 1604 may further be configured to receive from AP MLD 1602, in response to the frame requesting the transmission by AP MLD 1602 of the frame via the EHF link, a frame via the non-EHF link adding the EHF link with STA MLD 1604. In such an embodiment, STA MLD 1604 may be configured to not transmit to AP MLD 1602 a frame requesting the addition of the EHF link.

In accordance with the link setup process of FIG. 16, AP MLD 1602 may be configured to transmit a beacon (or other) frame via the non-EHF link. The beacon frame may indicate a threshold. AP MLD 1602 may further be configured to receive from STA MLD 1604 via the non-EHF link a frame requesting the transmission by AP MLD 1602 of a frame via the EHF link for detection by STA MLD 1604. In an embodiment, AP MLD 1602 may be configured to determine an RSSI of the frame received via the non-EHF link from STA MLD 1604 and to determine an establishment status of the EHF link based on the RSSI of the frame received via the non-EHF link from STA MLD 1604. In an embodiment, the establishment status of the EHF link indicates that the EHF link is established between STA MLD 1604 and AP MLD 1602 based on the RSSI of the frame received via the non-EHF link being greater than a second threshold and that the EHF link is not established between the STA MLD 1604 and AP MLD 1602 based on the RSSI of the frame received via the non-EHF link being lower than or equal to the second threshold. The second threshold may be the same as or different than the threshold indicated in the beacon frame. In an embodiment, AP MLD 1602 may be configured to transmit a frame (e.g., a beacon frame) indicating the establishment status of the EHF link with STA MLD 1604. In another embodiment, AP MLD 1602 may be further configured to transmit the frame via the EHF link for detection by STA MLD 1604, based on the RSSI of the frame received via the non-EHF link from STA MLD 1604 being less than or equal to the second threshold.

For example, as shown in FIG. 16, STA MLD 1604 may receive, via STA 1604-1 over the non-EHF link (5 GHz link), a beacon frame 1606 transmitted by AP MLD 1602, via AP 1602-1. STA MLD 1604 may determine an RSSI of beacon frame 1606 and may compare the RSSI of beacon frame 1606 to a threshold. The threshold may be pre-configured or may be indicated in beacon frame 1606.

In example 1600, for the purpose of illustration, it assumed that the RSSI of beacon frame 1606 is not greater than the threshold. As such, STA MLD 1604 may determine that it may set up the EHF link (60 GHz link) with AP MLD 1602 on condition of detecting a frame from AP MLD 1602 via the EHF link.

Based on determining that it may set up the EHF link with AP MLD 1602 based on detecting a frame from AP MLD 1602 via the EHF link, STA MLD 1604 may transmit a frame 1608 to AP MLD 1602 comprising a request for AP MLD 1602 to transmit the frame via the EHF link for detection by STA MLD 1604. Frame 1608 may be transmitted via the non-EHF link or the EHF link. Frame 1608 may be an action frame or a QoS null frame, for example.

On receiving frame 1608 from STA MLD 1604, STA MLD 1604 may be configured to determine an RSSI of frame 1608 and to determine an establishment status of the EHF link between AP MLD 1602 and STA MLD 1604 based on the RSSI of frame 1608. Specifically, AP MLD 1602 may determine that the EHF link is established between STA MLD 1604 and AP MLD 1602 based on the RSSI of frame 1608 being greater than a second threshold and that the EHF link is not established between the STA MLD 1604 and AP MLD 1602 based on the RSSI of frame 1608 being lower than or equal to the second threshold.

In example 1600, it assumed that the RSSI of frame 1608 is greater than the second threshold. As such, AP MLD 1602 may determine that the EHF link is established between STA MLD 1604 and AP MLD 1602. AP MLD 1602 may transmit a beacon frame 1610 indicating the establishment status of the EHF link between STA MLD 1604 and AP MLD 1602 and, particularly, that STA MLD 1604 is associated with AP MLD 1602 on the EHF link. On receiving beacon frame 1610, STA MLD 1604 may determine that the EHF link with AP MLD 1602 is added. STA MLD 1604 may begin using the EHF link for data communication with AP MLD 1602.

In another example (now shown in FIG. 16), the RSSI of frame 1608 may not be greater than the second threshold. As such, in response to frame 1608, AP MLD 1602 may transmit a frame via the EHF link for detection by STA MLD 1604. Based on detecting the frame via the EHF link, STA MLD 1604 may transmit a frame comprising a request to add or establish the EHF link as described above in FIG. 15. In an implementation, AP MLD 1602 may also transmit beacon frame 1610 before or after transmitting the frame via the EHF link. Beacon frame 1610 indicates the establishment status of the EHF link between STA MLD 1604 and AP MLD 1602. Depending on the transmission time of beacon frame 1610, the EHF link may be indicated as established or not established between STA MLD 1604 and AP MLD 1602.

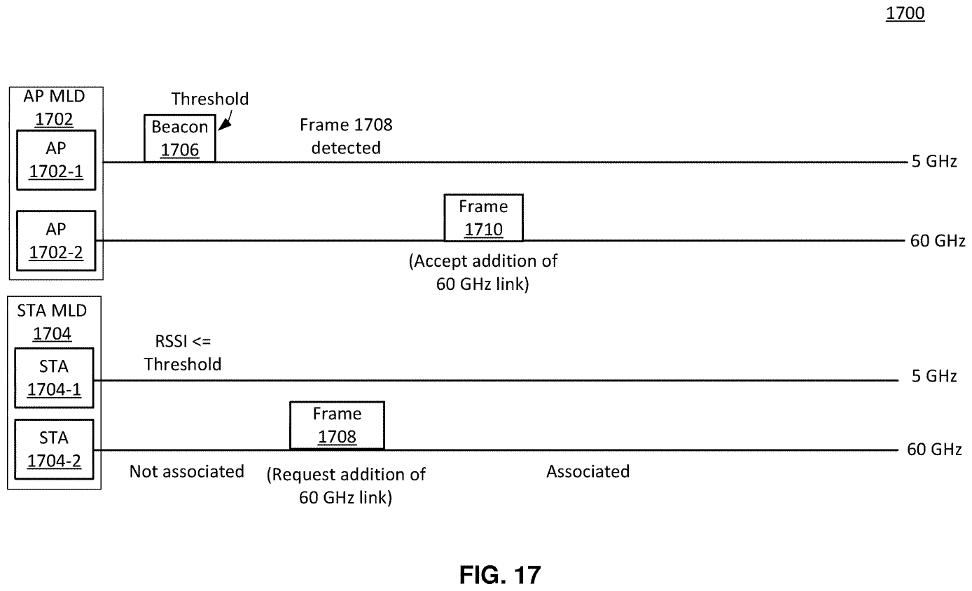

FIG. 17 illustrates an example 1700 of another link setup process according to an embodiment. Example 1700 is provided for the purpose of illustration only and is not limiting of embodiments of the present disclosure. As shown in FIG. 17, example 1700 includes an AP MLD 1702 and a STA MLD (or non-AP MLD) 1704. AP MLD 1702 has two affiliated APs: AP 1702-1 operating in the 5 GHz band and AP 1702-2 operating in the 60 GHz band. STA MLD 1704 has two affiliated STAs (or non-AP STAs): STA 1704-1 operating in the 5 GHz band and STA 1704-2 operating in the 60 GHz band.

In example 1700, STA MLD 1704 may perform a multi-link (re)setup (as described above with reference to FIG. 9) that results in the setup of a non-EHF link in the 5 GHz band between AP MLD 1702 and STA MLD 1704. At the end of the multi-link (re)setup, STA MLD 1704 becomes associated with AP MLD 1702. Specifically, STA 1704-1 affiliated with STA MLD 1704 becomes associated with AP 1702-1 affiliated with AP MLD 1702.

In accordance with the link setup process of FIG. 17, STA MLD 1704 may be configured to receive a beacon (or other) frame via the non-EHF link from AP MLD 1702, compare an RSSI of the beacon frame with a threshold, and determine, based on the comparison, respective operations to set up the EHF link with AP MLD 1602. Specifically, in an embodiment, when the RSSI of the beacon frame is not greater than the threshold, STA MLD 1604 may be configured to transmit a first frame to AP MLD 1602, via the EHF link, comprising a request to add the EHF link with AP MLD 1702. In response to the first frame, STA MLD 1604 may be configured to receive a second frame from AP MLD 1702, via the EHF link. The second frame may indicate an acceptance or a rejection of the request to add the EHF link. On the other hand, when the RSSI of the beacon frame is greater than the threshold, STA MLD 1604 may be configured to transmit a first frame to AP MLD 1602, via the non-EHF link, comprising a request to add the EHF link with AP MLD 1702. In response to the first frame, STA MLD 1604 may be configured to receive a second frame from AP MLD 1702, via the non-EHF link. The second frame may indicate an acceptance or a rejection of the request to add the EHF link.

In accordance with the link setup process of FIG. 17, AP MLD 1702 may be configured to transmit a beacon (or other) frame via the non-EHF link. The beacon frame may indicate a threshold. AP MLD 1702 may further be configured to receive from STA MLD 1704 via the EHF link a first frame comprising a request to add or establish the EHF link between STA MLD 1704 and AP MLD 1702. In an embodiment, based on detecting and/or decoding the first frame from STA MLD 1704, AP MLD 1702 may be configured to transmit to STA MLD 1704 via the EHF link a second frame accepting the request to add or establish the EHF link between STA MLD 1704 and AP MLD 1702.

For example, as shown in FIG. 17, STA MLD 1704 may receive, via STA 1704-1 over the non-EHF link (5 GHz link), a beacon frame 1706 transmitted by AP MLD 1702, via AP 1702-1. STA MLD 1704 may determine an RSSI of beacon frame 1706 and may compare the RSSI of beacon frame 1706 to a threshold. The threshold may be pre-configured or may be indicated in beacon frame 1706.

In example 1700, for the purpose of illustration, it assumed that the RSSI of beacon frame 1706 is not greater than the threshold. As such, STA MLD 1704 may transmit to AP MLD 1702, via the EHF link, a frame 1708 comprising a request to add or establish the EHF link between STA MLD 1704 and AP MLD 1702. Frame 1708 may comprise an association request frame, for example. It is assumed in example 1700, for the purpose of illustration, that AP MLD 1702 is able to detect and/or decode frame 1708. Based on detecting and/or decoding frame 1708, AP MLD 1702 may transmit to STA MLD 1704 via the EHF link a frame 1710 accepting the request to add or establish the EHF link between STA MLD 1704 and AP MLD 1702. On transmitting frame 1710, AP MLD 1702 may consider the EHF link (60 GHz link) added to the ML setup of STA MLD 1704 and STA 1704-2 becomes associated with AP 1702-2.

In another example (not shown in FIG. 17), AP MLD 1702 may not detect and/or decode frame 1708. As such, AP MLD 1702 may not transmit any frame in response to frame 1708. STA MLD 1704 remains not associated with AP MLD 1702 via the EHF link.

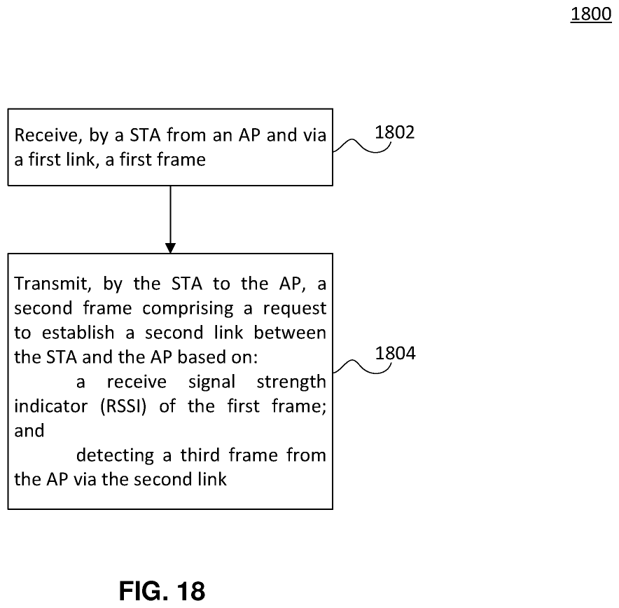

FIG. 18 illustrates an example process 1800 according to an embodiment. Example process 1800 is provided for the purpose of illustration only and is not limiting of embodiments of the present disclosure. Example process 1800 may be performed by a STA, such as STA MLD 1404 or STA MLD 1504. As shown in FIG. 18, example process 1800 may include steps 1802 and 1804.

Step 1802 includes receiving, from an AP and via a first link, a first frame. The first frame may be a beacon frame or an action frame, for example. The first link may a non-EHF link. For example, the first link may be a sub-7 GHz link (e.g., 2.4 GHz, 5 GHz, or 6 GHz).

Step 1804 includes transmitting, to the AP, a second frame comprising a request to establish a second link between the STA and the AP based on: a receive signal strength indicator (RSSI) of the first frame; and detecting a third frame from the AP via the second link. The second link may be an EHF link. For example, the second link may be a 60 GHz link.

In an embodiment, transmitting the second frame based on the RSSI of the first frame comprises determining that the RSSI of the first frame is less than a threshold. In an implementation, the threshold is greater than or equal to a carrier sense threshold associated with the first link. For example, the carrier sense threshold is one of −82 dBm, −72 dBm, and −62 dBm. In an implementation, the first frame indicates the threshold.

In an embodiment, the request to establish the second link between the STA and the AP comprises a request to add the second link to a multi-link (ML) setup between the AP and STA. In an implementation, the second frame comprises a link reconfiguration request frame. In an implementation, the second frame comprises a reconfiguration multi-link (ML) element.

In an embodiment, process 1800 may further comprise performing a multi-link setup process comprising the second link. In an embodiment, step 1804 may be a part of the multi-link setup process. In an implementation, the second frame comprises a basic multi-link (ML) element comprising link information of the second link. In an implementation, the second frame may be a (re)association request frame.

In an embodiment, process 1800 may further comprise mapping a traffic identifier (TID) to the second link. In an embodiment, the second frame comprises a TID-To-Link mapping request frame. The TID-to-Link mapping request frame may include a TID-to-Link mapping that requests mapping the second link to the TID.

In an embodiment, detecting the third frame comprises detecting a preamble of a PPDU carrying the third frame, the PPDU comprising a BSS color field indicating a BSS color value associated with the AP. In another embodiment, detecting the third frame comprises detecting a preamble of a PPDU carrying the third frame, the PPDU comprising a transmit address field indicating an address of the AP. In another embodiment, detecting the third frame further comprises detecting an uplink/downlink (UL/DL) field of the PPDU indicating that the PPDU is a DL PPDU.

In an embodiment, the third frame is transmitted to another STA by the AP. In another embodiment, the third frame comprises a CTS-to-self frame. In an embodiment, the third frame comprises a data frame.

In an embodiment, process 1800 may further comprise transmitting, by the STA to the AP and via the first link, a fourth frame comprising a request to transmit the third frame. The fourth frame may comprise an action frame or a QoS null frame.

In an embodiment, process 1800 may further comprise receiving, by the STA from the AP, a fifth frame indicating a response to the second frame. In an embodiment, the fifth frame comprises a link reconfiguration response frame. In another embodiment, the fifth frame comprises a (re)association response frame. In a further embodiment, the fifth frame comprises a beacon frame that indicates a link establishment status of the STA. The beacon frame may comprise an information element comprising the link establishment status of the STA. The link establishment status of the STA may indicate whether the second link is established between the STA and the AP.

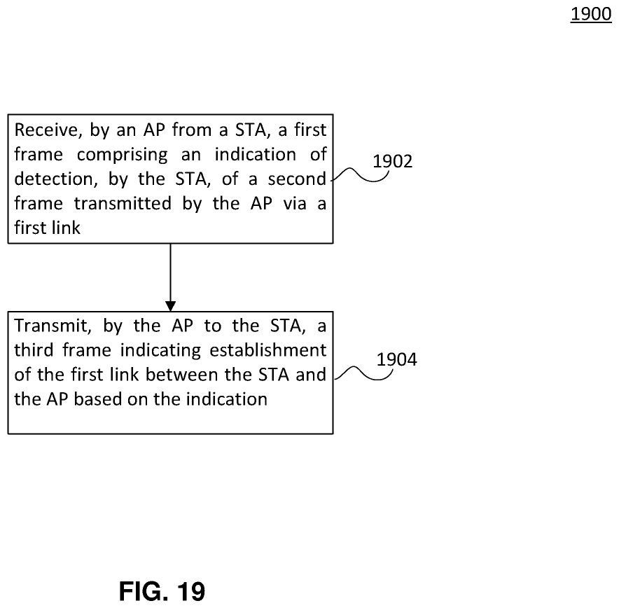

FIG. 19 illustrates an example process 1900 according to an embodiment. Example process 1900 is provided for the purpose of illustration only and is not limiting of embodiments of the present disclosure. Example process 1900 may be performed by an AP, such as AP MLD 1402 or AP MLD 1502. As shown in FIG. 19, example process 1900 may include steps 1902 and 1904.

Step 1902 includes receiving, from a STA, a first frame comprising an indication of detection, by the STA, of a second frame transmitted by the AP via a first link. The first link may an EHF link. For example, the first link may be a 60 GHz link.

In an embodiment, the first frame comprises a request to establish the first link between the STA and the AP. In an implementation, the request to establish the first link between the STA and the AP comprises a request to add the first link to a multi-link (ML) setup between the AP and STA. In an implementation, the first frame comprises a link reconfiguration request frame. In an implementation, the first frame comprises a reconfiguration multi-link (ML) element.

In an embodiment, process 1900 may further comprise performing a multi-link setup process comprising the first link. In an embodiment, step 1902 may be a part of the multi-link setup process. In an implementation, the first frame comprises a basic multi-link (ML) element comprising link information of the first link. In an implementation, the first frame may be a (re)association request frame.

In an embodiment, process 1900 may further comprise mapping a traffic identifier (TID) to the first link. In an embodiment, the first frame comprises a TID-To-Link mapping request frame. The TID-to-Link mapping request frame may include a TID-to-Link mapping that requests mapping the first link to the TID.

In an embodiment, receiving the first frame comprises receiving the first frame via the first link or a second link. The second link may a non-EHF link. For example, the second link may be a sub-7 GHz link (e.g., 2.4 GHz, 5 GHz, or 6 GHz).

In an embodiment, detection by the STA of the second frame comprises detection a preamble of a PPDU carrying the second frame, the PPDU comprising a BSS color field indicating a BSS color value associated with the AP. In another embodiment, detection by the STA of the second frame comprises detection of a preamble of a PPDU carrying the second frame, the PPDU comprising a transmit address field indicating an address of the AP. In another embodiment, detection by the STA of the second frame further comprises detection of an uplink/downlink (UL/DL) field of the PPDU indicating that the PPDU is a DL PPDU.

In an embodiment, the second frame is transmitted to another STA by the AP. In another embodiment, the second frame comprises a CTS-to-self frame. In an embodiment, the second frame comprises a data frame.

In an embodiment, process 1900 may further comprise receiving, by the AP from the STA, a fourth frame comprising a request to transmit the second frame. The fourth frame may comprise an action frame or a QoS null frame.

Step 1904 includes transmitting, to the STA, a third frame indicating establishment of the first link between the STA and the AP based on the indication. In an embodiment, the third frame comprises a link reconfiguration response frame. In another embodiment, the third frame comprises a beacon frame that indicates a link establishment status of the STA. The beacon frame may comprise an information element comprising the link establishment status of the STA. The link establishment status of the STA may indicate whether the first link is established between the STA and the AP.

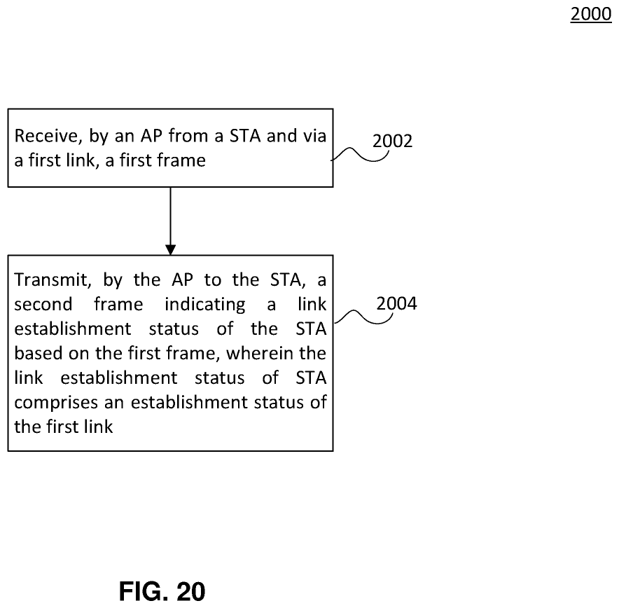

FIG. 20 illustrates an example process 2000 according to an embodiment. Example process 2000 is provided for the purpose of illustration only and is not limiting of embodiments of the present disclosure. Example process 2000 may be performed by an AP, such as AP MLD 1602. As shown in FIG. 20, example process 2000 may include steps 2002 and 2004.

Step 2002 includes receiving, from a STA and via a first link, a first frame. The first link may a non-EHF link. For example, the first link may be a sub-7 GHz link (e.g., 2.4 GHz, 5 GHz, or 6 GHz). The first frame may be an action frame or a QoS null frame, for example.

Step 2004 includes transmitting, to the STA, a second frame indicating a link establishment status of the STA based on the first frame. The link establishment status of STA may comprise an establishment status of a second link. The second link may be an EHF link. For example, the second link may be a 60 GHz link. The second frame may be a beacon frame or a probe response frame, for example.

In an embodiment, the link establishment status of the STA being based on the first frame comprises the link establishment status of the STA being based on a RSSI of the first frame at the AP. In an embodiment, the establishment status of the second link indicates that the second link is established between the STA and the AP based on the RSSI of the first frame being greater than a threshold. In an embodiment, the establishment status of the second link indicates that the second link is not established between the STA and the AP based on the RSSI of the first frame being lower than or equal to a threshold.

What is claimed is:

1. A station (STA) comprising:
one or more processors; and
memory storing instructions that, when executed by the one or more processors, cause the STA to:
receive, from an access point (AP) and via a first link, a first frame; and
transmit, to the AP, a second frame comprising a request to establish a second link between the STA and the AP based on:
a receive signal strength indicator (RSSI) of the first frame; and
detecting a third frame from the AP via the second link.

2. The STA of claim 1, wherein transmitting the second frame based on the RSSI of the first frame comprises determining that the RSSI of the first frame is less than a threshold.

3. The STA of claim 2, wherein the first frame indicates the threshold.

4. The STA of claim 1, wherein the request to establish the second link between the STA and the AP comprises a request to add the second link to a multi-link (ML) setup between the AP and STA.

5. The STA of claim 1, wherein the second frame comprises one or more of: (i) a reconfiguration multi-link (ML) element, (ii) a link reconfiguration request frame, or (iii) a basic ML element comprising link information of the second link.

6. The STA of claim 1, wherein the third frame is transmitted to another STA by the AP and wherein detecting the third frame comprises detecting a preamble of a physical layer protocol data unit (PPDU) carrying the third frame, the PPDU comprising a basic service set (BSS) color field indicating a BSS color value associated with the AP.

7. The STA of claim 1, wherein the first link comprises a sub- 7 GHz link and the second link comprises a 60 GHz link.

8. An access point (AP) comprising:
one or more processors; and
memory storing instructions that, when executed by the one or more processors, cause the AP to:
receive, from a station (STA) and via a first link, a first frame comprising an indication of detection, by the STA, of a second frame transmitted by the AP via a second link; and
transmit, to the STA, a third frame indicating establishment of the second link between the STA and the AP based on the indication.

9. The AP of claim 8, wherein the first frame comprises a request to establish the second link between the STA and the AP.

10. The AP of claim 9, wherein the request to establish the second link between the STA and the AP comprises a request to add the second link to a multi-link (ML) setup between the AP and STA.

11. The AP of claim 8, wherein the first frame comprises one or more of: (i) a reconfiguration multi-link (ML) element, (ii) a link reconfiguration request frame, or (iii) a basic multi-link (ML) element comprising link information of the first link.

12. The AP of claim 8, wherein the second frame is transmitted by the AP to a second STA.

13. The AP of claim 8, wherein the third frame comprises one or more of: (i) a link reconfiguration response frame, (ii) a beacon frame, or (iii) a CTS-to-self frame.

14. The AP of claim 8, wherein the first link comprises a sub-7 GHz link and the second link comprises a 60 GHz link.

15. A non-transitory computer-readable medium comprising instructions that, when executed by one or more processors of a station (STA), cause the STA to:
receive, from an access point (AP) and via a first link, a first frame; and
transmit, to the AP, a second frame comprising a request to establish a second link between the STA and the AP based on:
a receive signal strength indicator (RSSI) of the first frame; and
detecting a third frame from the AP via the second link.

16. The non-transitory computer-readable medium of claim 15, wherein transmitting the second frame based on the RSSI of the first frame comprises determining that the RSSI of the first frame is less than a threshold.

17. The non-transitory computer-readable medium of claim 15, wherein the request to establish the second link between the STA and the AP comprises a request to add the second link to a multi-link (ML) setup between the AP and STA.

18. The non-transitory computer-readable medium of claim 15, wherein the second frame comprises one or more of:
(i) a reconfiguration multi-link (ML) element, (ii) a link reconfiguration request frame, or (iii) a basic ML element comprising link information of the second link.

19. The non-transitory computer-readable medium of claim 15, wherein the third frame is transmitted to another STA by the AP and wherein detecting the third frame comprises detecting a preamble of a physical layer protocol data unit (PPDU) carrying the third frame, the PPDU comprising a basic service set (BSS) color field indicating a BSS color value associated with the AP.

20. The non-transitory computer-readable medium of claim 15, wherein the first link comprises a sub-7 GHz link and the second link comprises a 60 GHz link.
